(19) United States
(12) Patent Application Publication
(10) Pub. No.: US 2024/0053188 A1
(43) Pub. Date: Feb. 15, 2024

(54) ARTICLE IDENTIFICATION SYSTEM, ARTICLE IDENTIFICATION METHOD, NON-TRANSITORY COMPUTER-READABLE STORAGE MEDIUM, AND ARTICLE ACQUISITION DETERMINATION SYSTEM

(71) Applicant: Hitachi-LG Data Storage, Inc., Tokyo (JP)

(72) Inventors: Kenji AKAHOSHI, Tokyo (JP); Hisahiro HAYASHI, Tokyo (JP); Norimoto ICHIKAWA, Tokyo (JP)

(21) Appl. No.: 18/200,624

(22) Filed: May 23, 2023

(30) Foreign Application Priority Data
Aug. 10, 2022 (JP) 2022-128199

(51) Int. Cl. G01G 19/52

(52) U.S. Cl. CPC G01G 19/52

(57) ABSTRACT

An article identification system includes a weight sensor, a distance sensor, and an article identification device including an information processing device. The information processing device calculates, based on weight measurement data detected by the weight sensor, a first item picked up position of a plurality of picked up estimated items and a degree of accuracy indicating a degree of correctness of the estimation of the picked up estimated items. The information processing device obtains a second item picked up position based on the distance data of the person obtained by the distance sensor. The information processing device calculates a correction certainty by correcting the certainty of the estimated picked up items based on the first item picked up position and the second item picked up position, and identifies the picked up items based on the correction certainty.

### CROSS-REFERENCE TO RELATED APPLICATION

The present application claims priority from Japanese application JP2022-128199, filed on Aug. 10, 2022, the content of which is hereby incorporated by reference into this application.

### BACKGROUND OF THE INVENTION

### Field of the Invention

The present invention relates to an article identification system, an article identification method, a non-transitory computer-readable storage medium, and an article acquisition determination system.

### Description of the Related Art

Patent Document 1 (WO No. 2020/179480) discloses an article estimation device (hereinafter referred to as a “conventional device”) for estimating an article picked up from a shelf on which a plurality of articles is placed.

The conventional device is a device for estimating the weight of an article picked up from a shelf on which a plurality of articles is placed. The conventional device acquires weight change data based on changes in detection values of a weight sensor installed on a shelf on which a plurality of articles is placed and acquires motion data indicating hand movements of a person located in a space in front of the shelf. The conventional device uses the weight change data and the motion data to estimate the articles picked up from the shelf at different heights by the hand of the person.

### SUMMARY OF THE INVENTION

However, the conventional device could not estimate the number of articles picked up at the same time from different positions on the same shelf. The present invention has made to solve the above problem. That is, an object of the present invention is to provide an article identification system, an article identification method, a non-transitory computer-readable storage medium, and an article acquisition determination system that can accurately identify articles picked up simultaneously from different positions on the same shelf.

To solve the above problem, the present disclosed article identification system comprises:
a weight sensor that measures a weight of an article, the weight sensor being installed on a shelf on which the article is placed;
a distance sensor that includes the shelf and a predetermined area in front of the shelf in a measurement range and measures a distance to an object to be measured that is present in the measurement range; and
an article identification device including an information processing device that acquires weight measurement data that is the weight measured with the weight sensor, and distance data that are the distance representing a person present within the measurement range measured with the distance sensor.

The information processing device is configured to:
estimate, based on the weight measurement data when the article is picked up from the shelf, the article picked up from the shelf;
calculate, for each of a plurality of picked up estimated articles, a first article picked up position that is an estimated picked up position of the picked up estimated article and a degree of accuracy indicating a degree of correctness of estimation of the picked up estimated article;
obtain, based on the distance data of the person, a second article picked up position based on a position of a predetermined part of the person when the person picks up the article from the shelf;
calculate a corrected accuracy by correcting the accuracy for each of the picked up estimated articles based on the first article picked up position and the second article picked up position; and
identify, based on the corrected accuracy, one or more picked up articles that are picked up from the shelf from among the picked up estimated articles.

The present disclosed article identification method to be performed uses
a weight sensor that measures a weight of an article, the weight sensor being installed on a shelf on which the article is placed;
a distance sensor that includes the shelf and a predetermined area in front of the shelf in a measurement range and measures a distance to an object to be measured that is present in the measurement range; and
an article identification device including an information processing device that acquires weight measurement data that is the weight measured with the weight sensor, and distance data that are the distance representing a person present within the measurement range measured with the distance sensor.

The article identification method comprises:
estimating, based on the weight measurement data when the article is picked up from the shelf, the article picked up from the shelf;
calculating, for each of a plurality of picked up estimated articles, a first article picked up position that is an estimated picked up position of the picked up estimated article and a degree of accuracy indicating a degree of correctness of estimation of the picked up estimated article;
obtaining, based on the distance data of the person, a second article picked up position based on a position of a predetermined part of the person when the person picks up the article from the shelf;
calculating a corrected accuracy by correcting the accuracy for each of the picked up estimated articles based on the first article picked up position and the second article picked up position; and
identifying, based on the corrected accuracy, one or more picked up articles that are picked up from the shelf from among the picked up estimated articles.

The present disclosed non-transitory computer-readable storage medium storing a computer-executable program for execution by a computer uses:
weight measurement data obtained by a weight sensor that measures a weight of an article, the weight sensor being installed on a shelf on which the article is placed; and
distance data obtained by distance sensor that includes the shelf and a predetermined area in front of the shelf in a measurement range and measures a distance to an object to be measured that is present in the measurement range, the distance data being a distance representing a person present within the measurement range measured with the distance sensor.

The program comprises instructions for:
estimating, based on the weight measurement data when the article is picked up from the shelf, the article picked up from the shelf;
calculating, for each of a plurality of picked up estimated articles, a first article picked up position that is an estimated picked up position of the picked up estimated article and a degree of accuracy indicating a degree of correctness of estimation of the picked up estimated article;
obtaining, based on the distance data of the person, a second article picked up position based on a position of a predetermined part of the person when the person picks up the article from the shelf;
calculating a corrected accuracy by correcting the accuracy for each of the picked up estimated articles based on the first article picked up position and the second article picked up position; and
identifying, based on the corrected accuracy, one or more picked up articles that are picked up from the shelf from among the picked up estimated articles.

The present disclosed article acquisition determination system comprises:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article.

In a first situation, where a first article is placed in a first region of the shelf in the center of the shelf in one direction, a second region and a third region flanking the first region on both sides in the one direction, a second article is placed in the second region, and a third article is placed in the third region,
the first determination unit determines that the plurality of candidate articles includes one second article and one third article, and that the most valid candidate article is the one second article and the next most valid candidate article is the one third article, and
when the second determination unit determines that the first person has made a movement toward the third article, the third determination unit determines that the first person has acquired the third article.

The present disclosed article acquisition determination system comprises:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article.

In the second situation, where a first article is placed in a first area, a second article is placed in a second area, and a third article is placed in a third area, the first area being substantially in the center of the shelf in one direction of the shelf, a second and third areas sandwiching the first area on both sides in the one direction, and where the weight of the second article and the weight of the third article are approximately equal and the weight of the first article is approximately twice the weight of the second article,
when the first determination unit determines that the plurality of candidates for the article are one first article, one second article, and one third article, when the most valid candidate article is the one first article and the next most valid candidate articles are the one second article and the one third article and when the second determination unit determines that the first person has made a movement toward the second article and the second person made a movement toward the third article,
the third determination unit determines that the first person has obtained the second article and the second person has obtained the third article.

The present disclosed article acquisition determination system comprises:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article.

In the second situation, where a first article is placed in a first area, a second article is placed in a second area, and a third article is placed in a third area, the first area being substantially in the center of the shelf in one direction of the shelf, a second and third areas sandwiching the first area on both sides in the one direction, and where the weight of the second article and the weight of the third article are approximately equal and the weight of the first article is approximately twice the weight of the second article,
when the first determination unit determines that the plurality of candidates for article are one first article, one second article, and one third article, and the most valid candidate articles are the one second article and the one third article, and the next most valid candidate article is the one first article and when the second determination unit determines that the first person made a movement toward the first article,
the third determination unit determines that the first person has obtained the first article.

The present disclosed article acquisition determination system comprises:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article.

In the second situation, where a first article is placed in a first area, a second article is placed in a second area, and a third article is placed in a third area, the first area being substantially in the center of the shelf in one direction of the shelf, a second and third areas sandwiching the first area on both sides in the one direction, and where the weight of the second article and the weight of the third article are approximately equal and the weight of the first article is approximately twice the weight of the second article,
when the first determination unit determines that the plurality of candidates for article is one first article, one second article and one third article, and the most valid candidate article is one first article and the next most valid candidate article is one second article and one third article, and when the second determination unit determines that the first person has made a movement toward the second article and the third article,
the third determination unit determines that the first person has obtained the one second article and the one third article.

The present disclosed article acquisition determination system comprises:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article.

When the article determined to have the highest validity by the first determination unit does not match the article determined by the second determination unit, and the article determined to have the second highest validity by the first determination unit matches the article determined by the second determination unit,
the third determination unit determines that the article determined by the second determination unit has been obtained.

According to the invention, articles picked up simultaneously from different positions on the same shelf can be identified with high accuracy.

### BRIEF DESCRIPTION OF DRAWINGS

FIG. 1 illustrates an example of an unattended merchandise sales store to which the article identification system according to a first embodiment of the present invention is applied.

FIG. 2 shows a flowchart of the operation from the time a user enters the unattended merchandise sales store to the time the user leaves.

FIG. 3 is a schematic diagram showing an example configuration of the article identification system according to the first embodiment of the present invention.

FIG. 4 illustrates item management information.

FIG. 5 illustrates information on a shelf to be stored in the item management information.

FIG. 6 shows a schematic diagram of an example hardware configuration of an item identification system.

FIG. 7 illustrates problems with a reference example of the article identification system.

FIG. 8A illustrates Example 1 of the operation of the article identification device.

FIG. 8B illustrates Example 1 of the operation of the article identification device.

FIG. 9A illustrates Example 2 of the operation of the article identification device.

FIG. 9B illustrates Example 2 of the operation of the article identification device.

FIG. 10A illustrates Example 3 of the operation of the article identification device.

FIG. 10B illustrates Example 3 of the operation of the article identification device.

FIG. 11A illustrates Example 4 of the operation of the article identification device.

FIG. 11B illustrates Example 4 of the operation of the article identification device.

FIG. 12A illustrates Example 5 of the operation of the article identification device.

FIG. 12B illustrates Example 5 of the operation of the article identification device.

FIG. 13 is a flowchart showing the processing flow executed by the article identification system.

FIG. 14 is a flowchart showing the processing flow executed by the item position determination unit (for integration) of the article identification device.

FIG. 15 illustrates the operation of the article identification device of the article identification system according to the second embodiment.

FIG. 16 illustrates the operation of the article identification device of the article identification system according to the third embodiment.

FIG. 17 illustrates another variant of the article acquisition determination system.

### DETAILED DESCRIPTION OF THE EMBODIMENT

Each embodiment of the present invention will be described below with reference to the drawings. In all figures of the embodiments, identical or corresponding parts may be marked with the same symbol.

In the following explanations, various types of information may be described in a tabular format or in expressions such as records, but various types of information may be expressed in data structures other than these. Furthermore, when describing identification information, expressions such as “name,” “identification ID,” and “number” are used, but these can be replaced with each other. Furthermore, in the following description, a program or functional block may be used as the subject to explain the process, but the subject of the process may be a CPU or an information processing device instead of the program or functional block.

### First Embodiment

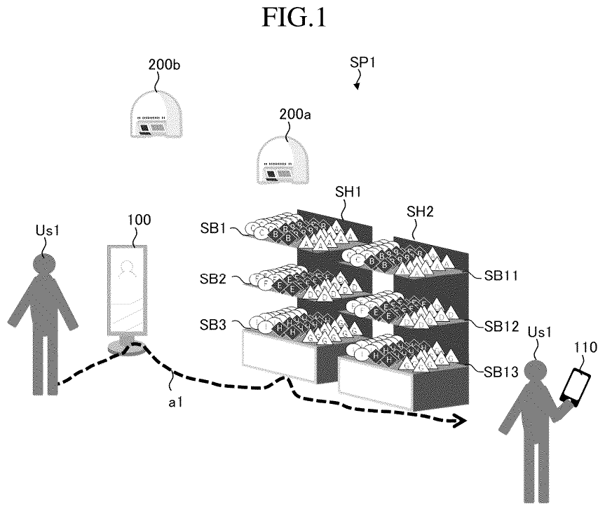

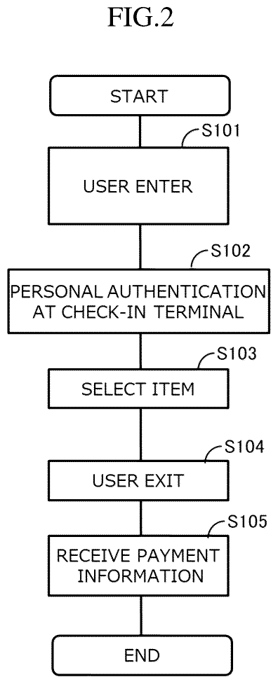

FIG. 1 illustrates an example of an unattended merchandise sales store SP1 to which an article identification system according to the first embodiment of the present invention is applied. FIG. 2 is a flowchart showing the behavior of the user in the unattended merchandise sales store SP1 from the time a user enters the store SP1 until the user leaves the store SP1.

As shown in FIG. 1, the unattended merchandise sales store SP1 has a check-in terminal 100, a distance sensor 200a and a distance sensor 200b located on the ceiling (not shown), a shelf SH1 including shelves SB1 through SB3 on which items are placed, and a shelf SH2 including shelves SB11 through SB13 on which items are placed. It should be noted that the shelf SH1 and the shelf SH2 may also be referred to as the “shelf SH” when there is no need to specifically distinguish between them. The shelves SB1 through SB3, and the shelves SB11 through SB13 may also be referred to as the “shelf SB” when there is no need to distinguish between them. The shelf SB is also referred to as a shelf board. The item may also be referred to as an “article”.

The check-in terminal 100 is a terminal for user authentication. The distance sensor 200a and the distance sensor 200b measure the distance (distance data) to measurement objects (objects) that is present in the measurement range.

The distance sensor 200a is a distance sensor for acquiring distance data for detecting the position of a hand extended toward an item (article) placed on the shelf SB of the shelf SH. The distance sensor 200b is a distance sensor for tracking a line of movement to acquire distance data for generating a line of movement of a person in the store (a line indicating the path of movement of the person). In this example, the distance sensor 200a and the distance sensor 200b are TOF (Time Of Flight) sensors.

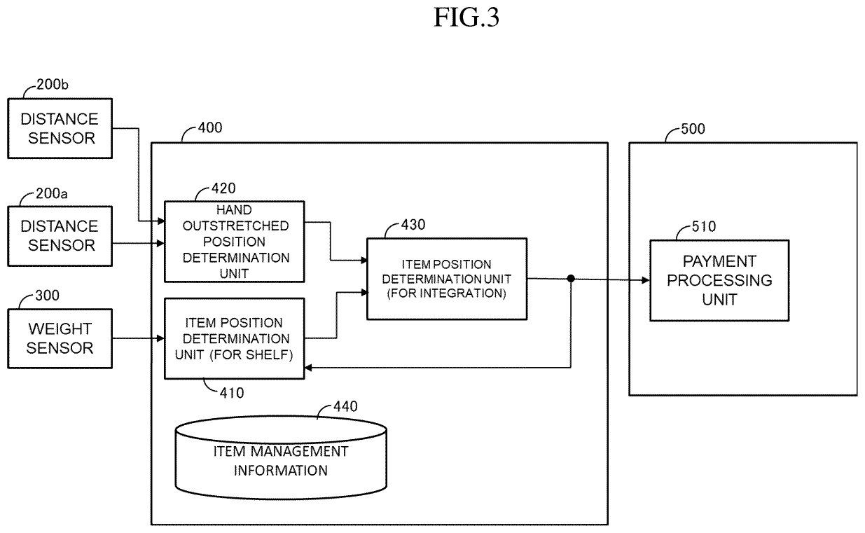

As shown in FIG. 1 and FIG. 2, a user Us1 enters the unattended merchandise store SP1 (S101) and moves along arrow al. The user Us1 performs personal authentication at the check-in terminal 100 for check-in (S102). The user Us1 selects an item placed on the shelf SB of the shelf SH and picks it up by hand (S103). At this time, an article identification device 400 (see FIG. 3) detects that the user Us1 has selected the item and picks it up by hand (S103). The item picked up by the user Us1 (referred to as the “picked up item”) is determined (identified) by the article identification device 400 (see FIG. 3). The item picked up by the user Us1 (referred to as the “item picked up”) is determined (identified) by a payment processing device 500 (see FIG. 3) determines (identifies) the item picked up by the user Us1 (referred to as the “picked up item”). The payment processing device 500 (see FIG. 3) automatically settles the payment for the picked up item. When the user Us1 leaves the unattended merchandise sales store SP1 (S104), a user terminal 110 receives the payment information (S105).

FIG. 3 is a schematic diagram showing an example configuration of the article identification system according to the first embodiment of the present invention. As shown in FIG. 3, this article identification system includes the distance sensor 200a, the distance sensor 200b, a weight sensor 300, the article identification device 400, and the payment processing device 500. These are communicatively connected via a network, which is not shown in the figure. Accordingly, the article identification device 400 is capable of receiving information (data) from the distance sensor 200a, the distance sensor 200b, and the weight sensor 300, and the payment processing device 500 is capable of receiving information from the article identification device 400. The article identification system may be configured so that the payment processing device 500 is omitted. The article identification system may also be referred to as an “article acquisition determination system”.

The distance sensor 200a is installed on the ceiling surface of the unattended merchandise sales store SP1, which is not shown in the figure. The distance sensor 200a includes a predetermined area in front of the shelves SH1 and SH2 in its measurement range.

The weight sensor 300 is installed on each shelf SB of the shelf SH1 and measures the weight of the item to obtain weight changes (changes in total weight and weight balance) when the item is picked up from the shelf SH1. The weight (measured value) measured by the weight sensor 300 may also be referred to as “weight measurement data” for convenience.

In this example, the shelf SH1 includes the shelves SB1 through SB3 having a rectangular planar shape, and the weight sensors 300 are installed at the four corners of each shelf SB1 through SB3. The shelf SH2 includes the shelves SB11 through SB13 having a rectangular planar shape, and the weight sensors 300 are installed at the four corners of each shelf SB11 through SB13.

The article identification device 400 includes an item position determination unit (for shelf) 410, a hand outstretched position determination unit 420, a final item position determination unit (for integration) 430, and item management information 440.

The item position determination unit (for shelf) 410 determines (determines and obtains) the position of estimated items (hereinafter referred to as “picked-up estimated items”) estimated to have been picked up from the shelf SB based on the weight change (change in total weight and weight balance) detected by the weight sensors 300. This position is also referred to as an “item acquisition event position”. The X-direction position Xw of the item acquisition event position may also be referred to simply as a “X-direction position Xw. In the article identification device 400, the X-direction is the width direction of the shelf SH, and the Y-direction is the direction orthogonal to the X-direction in a horizontal plane parallel to the ground.

The hand outstretched position determination unit 420 determines (determines and obtains) the position of the hand of the user Us1 when the user Us1 picks up an item from the shelf SH. The hand outstretched position determination unit 420 acquires, as this hand position, the position where the point group representing the hand of the user Us1 in the distance data (point group) of the user Us1 detected by the distance sensor 200a and the distance sensor 200b passes a predetermined position in front of the shelf SH.

This position is also referred to as an “item picked up position Xt. The item picked up position Xt may also be referred to as the “second article picked up position” for convenience. The X-direction position Xw and the item picked up position Xt described above are expressed in terms of coordinate values in a common coordinate system.

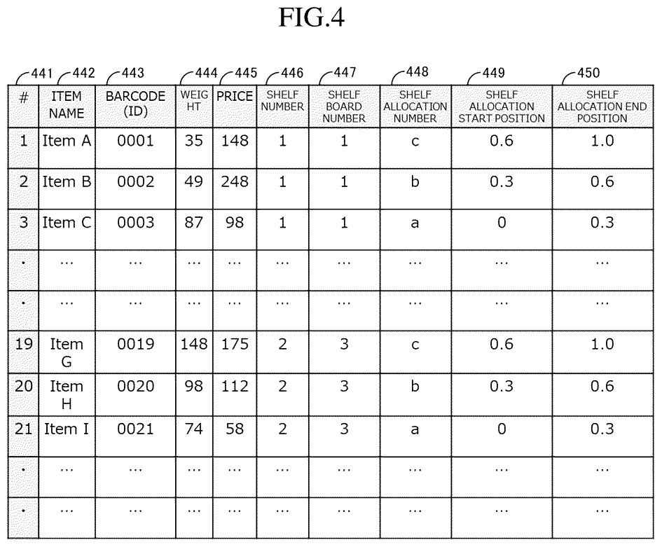

FIG. 4 illustrates the item management information 440. As shown in FIG. 4, the item management information 440 contains the following columns to store information (values): #441, item name 442, barcode (id) 443, weight 444, price 445, shelf number 446, shelf board number 447, shelf allocation number 448, shelf allocation start position 449, and shelf allocation end position 450. In the item management information 440, information corresponding to each column for managing items placed on the shelf SH is associated with each other and stored as information (record) in units of rows.

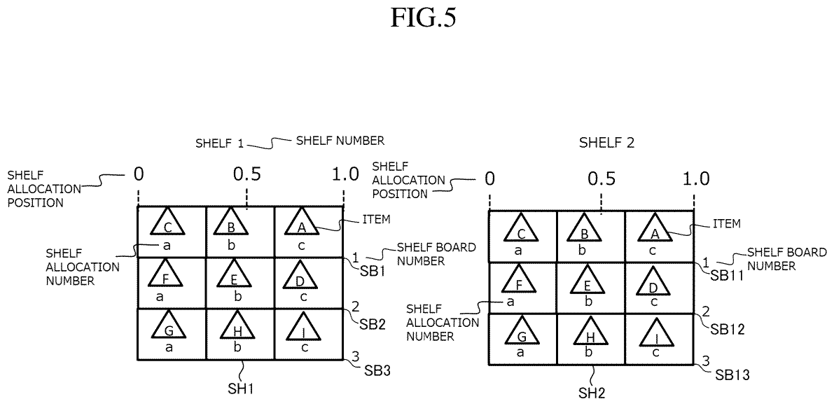

Specifically, #441 stores the row number. The item name 442 stores the name of the item. Barcode (id) 443 stores the identification ID of the item. Weight 444 stores the weight of the item. Price 445 contains the price of the item. Shelf number 446 contains the shelf numbers corresponding to the shelves SH1 and SH2 shown in FIG. 5. Shelf board number 447 contains the shelf number corresponding to each shelf SB shown in FIG. 5. Shelf allocation number 448 contains the shelf allocation number for each shelf allocation row shown in FIG. 5. The shelf allocation start position 449 contains the start position of the range of shelf allocation rows shown in FIG. 5. The shelf allocation end position 450 contains the end position of the range of shelf allocation rows shown in FIG. 5.

The payment processing device 500 includes a payment processing unit 510. The payment processing unit 510 processes the item(s) identified by the article identification device 400 for settlement.

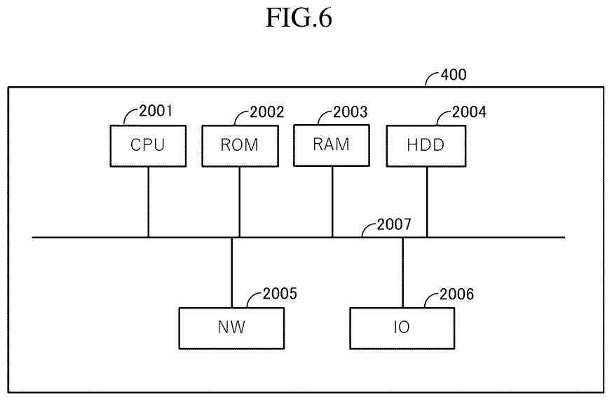

FIG. 6 shows a schematic diagram of an example hardware configuration of the article identification device 400. As shown in FIG. 6, the article identification device 400 includes a CPU 2001, a ROM 2002, a RAM 2003, a storage device 2004, a network interface 2005, and an input/output interface 2006, etc. The device including the CPU 2001, the ROM 2002, the RAM 2003, the storage device 2004, the network interface 2005, the input/output interface 2006, and bus 2007 is also referred to as an “information processing device” for convenience. The information processing device may be multiple information processing devices or a virtual information processing device in the cloud.

The CPU 2001 loads various programs stored in the ROM 2002 and/or the storage device 2004, which are not shown in the figure, into the RAM 2003 and executes the programs loaded into the RAM 2003 to realize various functions. Various programs to be executed by the CPU 2001 are loaded into the RAM 2003 as described above, and data used when the CPU 2001 executes various programs is temporarily stored in the RAM 2003. The ROM 2002 is a nonvolatile storage medium and stores various programs. The storage device 2004 is a nonvolatile storage device capable of reading and writing data. The network interface 515 is an interface for the article identification device 400 to be connected to a network. The input/output interface 2006 is an interface for connection to external devices (e.g., operating devices such as keyboard, mouse, etc., and display (display device)).

The item position determination unit (for shelf) 410, the hand outstretched position determination unit 420, and the item position determination unit (for integration) 430 are configured by various programs stored in the ROM 2002 and/or the storage device 2004 that are executed by the CPU 2001. The item management information 440 is composed of a database stored in the storage device 2004. The example hardware configuration of the payment processing device 500 is the same as in FIG. 6. The payment processing unit 510 is configured by various programs stored in the ROM 2002 and/or the storage device 2004 that are executed by the CPU 2001.

<Problems with a Reference Example of an Article Identification Device>

In order to facilitate understanding of the present invention, the problems of the reference example of the article identification system using only a weight sensor are described. In the example described below, an example of picking up an item from the top shelf SB1 of the shelf SH1 with shelf number 1 (the same applies to Examples 1 through 5 described below) is described. The following is a description of the following example.

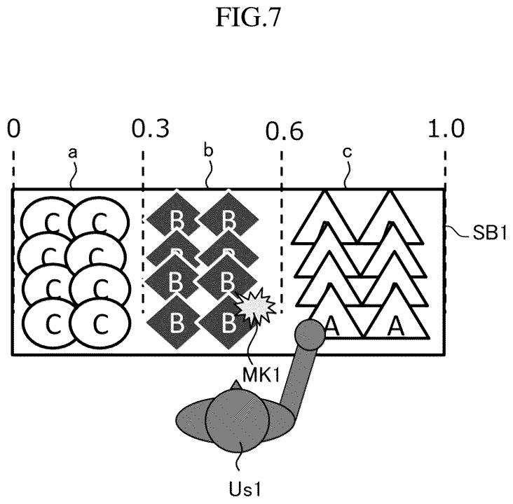

As shown in FIG. 7, the shelf SB1 is divided into three rows: a row a with an X-direction position (position in the width direction) of 0 to less than 0.3, a row b with an X-direction position of 0.3 to less than 0.6, and a row c with an X-direction position of 0.6 to less than 1.0. A mark MK1 in FIG. 7 indicates the position where the item acquisition event occurs. The item acquisition event occurrence position is a position calculated (estimated) using the measured value of the weight sensor 300. The details of the calculation method of the item acquisition event occurrence position are described below.

A plurality of items C is placed in shelf allocation row a, a plurality of items B is placed in shelf allocation row b, and a plurality of items A is placed in shelf allocation row c. The article identification device can obtain information indicating the type, weight, price, etc. of the items placed in each shelf-allocated row by referring to the item management information 440.

When the user Us1 picks up item A that is present in the vicinity of the right side of X direction position 0.6, an item acquisition event may occur at X direction position Xw 0.55 indicated by the mark MK1. In this case, if the picked up item is determined based only on the X direction position Xw, the picked up item will be item B. Therefore, it may happen that item B is determined (specified) as the picked up item even though item A is actually picked up from the shelf SB1. Thus, the reference example of the article identification device has the problem of low accuracy in identifying the article to be picked up.

<Overview of the Operation of the Present Invention>

To solve these problems, the article identification device 400 of the article identification system according to the present invention uses the measurements of the weight sensor 300 to estimate the picked up estimated item. The article identification device 400 calculates a parameter indicating the position of the picked up estimated item and the degree of correctness of the estimation of the picked up estimated item, the degree of accuracy (in this example, the likelihood Pw) for each picked up item.

Further, the article identification device 400 corrects the certainty (in this example, the likelihood Pw) of each picked up estimated item based on the X-direction position Xw and the hand position when the user Us1 picks up the item detected by the distance sensor 200a and the distance sensor 200b. The article identification device 400 identifies (determines) the item to be picked up from among the estimated items to be picked up based on the corrected probability (in this example, the corrected likelihood Pnew). In this way, the article identification device 400 can improve the accuracy of identifying the picked up item.

(Calculation of the Position of the Item Acquisition Event and the Likelihood Pw)

The following describes the calculation method of the item acquisition event occurrence position and the likelihood Pw performed by the item position determination unit (for shelf) 410 of the article identification device 400. The weight sensors 300 are installed at the four corners of each shelf SB of the shelf SH. When an item on the shelf SB is picked up, the weight balance of the item and the shelf SB changes, and the measured values of each weight sensor 300 in the four corners change. Based on the changes in the total weight and weight balance of the item and the shelf SB measured by each weight sensor 300, the article identification device 400 estimates the picked up estimated item and calculates the position of the picked up estimated item (i.e., the position where the item acquisition event occurs) and the likelihood Pw of the picked up estimated item for each estimated item Pw.

As an example, the picked up estimated item when an item on shelf SB is picked up, the position of each picked up estimated item (item acquisition event occurrence position), and the likelihood Pw can be calculated by using an arithmetic model in which the measured value of each weight sensor 300 within a predetermined measurement time is input, and the picked up estimated item, the item acquisition event occurrence position and the likelihood Pw of each picked up estimated item are output.

It should be noted that the likelihood Pw indicates the probability of an event in which the estimated item (one or more simultaneously estimated items) is actually picked up according to the measured values of each of the weight sensors 300 (changes in the total weight of the shelf SB (the shelf SB with items on it) and the weight balance during a given time). The likelihood Pw is expressed as a number in the range from 0 to 1. The likelihood Pw is an example of certainty, which is a parameter indicating the degree of correctness of the estimation of the picked up estimated item, and the certainty may be a parameter other than the likelihood Pw.

The measurement of weight by each weight sensor 300 need not be made only once, but may be made continuously, periodically or randomly, so that changes in weight are measured over a predetermined time or a predetermined number of times. The item position determination unit (for shelf) 410 calculates the weight distribution on the shelf SB, as disclosed in U.S. Patent Application Publication No. US2021/0148751, etc., and maps and evaluates it to calculate the estimated items to be picked up, the position of the item acquisition event occurrence for each estimated item and the probability (the event likeliness score) may be calculated by mapping and evaluating the weight distribution on the shelf SB.

In reality, the measured values of the four weight sensors 300 contain errors, and the total weight and weight balance of the item and shelf SB calculated by them also contain errors. For example, the measured weight of each weight sensor 300 may fluctuate due to vibrations or oscillations of the shelf SB caused by, for example, the user Us1 pressing down on the shelf SB when taking up an item or the user Us1 touching the shelf SB, and the change in total weight and weight balance due to item acquisition alone may not be accurately measured. As an example of this countermeasure, the following may be taken. The item position determination unit (for shelf) 410 measures the weight multiple times continuously, periodically or randomly over a predetermined time or predetermined number of times by the weight sensors 300. If the measured value of each weight sensor 300 fluctuates beyond a predetermined threshold value, the item position determination unit (for shelf) 410 re-measures the weight for up to a predetermined number of times or for a predetermined amount of time. If, as a result of the re-measurement, the measured value of each weight sensor 300 falls within the aforementioned predetermined threshold value, the item position determination unit (for shelf) 410 adopts the re-measurement result (measured value of each weight sensor 300).

For the picked up estimated item for which the likelihood Pw is lower than a predetermined value, the system may request confirmation from the user Us1 or may allow the user Us1 to modify the target item at the time of checkout (before settlement). For example, if the difference in likelihood Pw (or price) between the initially presented candidate item (picked up estimated item) and the item modified by the user Us1 is within the predetermined range, the customer's modification may be accepted. If the difference exceeds the aforementioned predetermined range, the user Us1 may be prompted to reconfirm or send a store clerk to confirm.

(Method of Determining the Hand Outstretched Position)

The hand extension position determination unit 420 of the article identification device 400 uses the distance measurement sensors 200a and 200b to detect, as “the position of the hand of the user Us1 when picking up the item from the shelf SB”. a position in the X direction when the hand of the person indicated by the distance measurement data (point cloud) passes through a virtual face parallel to the height direction of the shelf SH installed (set) at a predetermined position in front of the shelf SH (shelf SB), The hand extension position determination unit 420 acquires the detected position in the X direction as the item picked up position Xt, The virtual face parallel to the height direction of the shelf SH is also referred to as a “virtual screen”, “The position of the hand of the user Us1 when picking up the item from the shelf SB” is simply referred to as the “hand outstretched position”,

(Likelihood Correction)

The item position determination unit (for integration) 430 of the article identification device 400 corrects the likelihood Pw for the picked up estimated item by applying the likelihood Pw, the X-direction position Xw of the item acquisition event occurrence position and the item picked up position Xt to the following Formula (1) to calculate the corrected likelihood Pnew.

Pnew=Pw−α×|Xw−Xt| Formula (1)

(In Formula (1), Pnew is the correction likelihood Pnew. Xw is the X-direction position Xw of the item acquisition event occurrence position. Xt is the item picked up position Xt. α is the weighting factor.)

It should be noted that the value of α in Formula (1) used in Examples 1 through 5 described below is “2”.

### Example 1

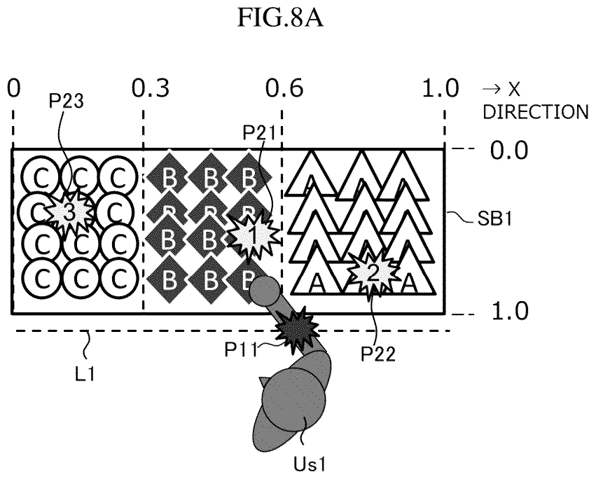

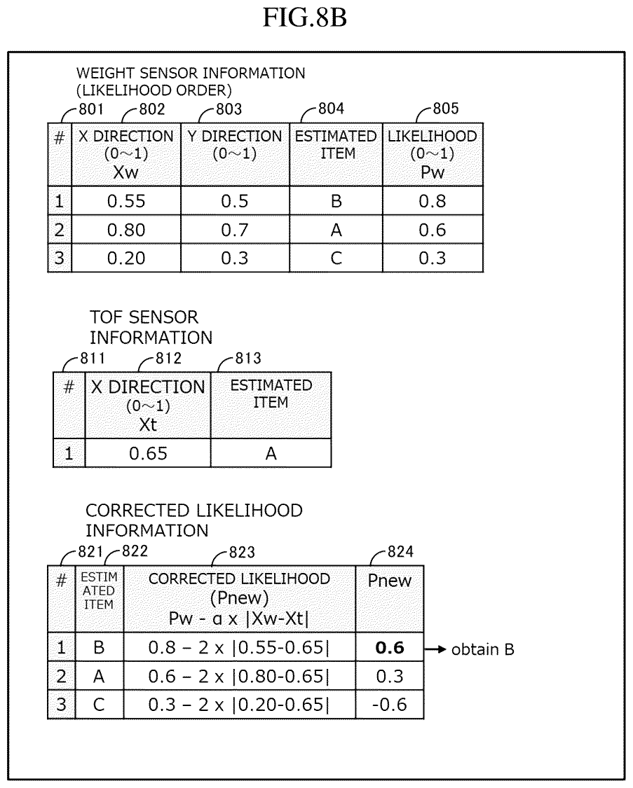

FIG. 8A and FIG. 8B illustrate the specific Example 1 of operation of the article identification device 400. Assume a situation in which the hand outstretched position is detected, a weight change (change in total weight and weight balance) is detected by the weight sensors 300, and an item acquisition event occurs at positions P21, P22, and P23. It should be noted that in FIG. 8A, the position of the virtual screen is indicated by the dashed line L1.

The item position determination unit (for shelf) 410 of the article identification device 400 calculates the weight sensor information shown in FIG. 8B based on the measured values of the weight sensors 300 and the item management information 440. The weight sensor information includes #801, X direction (0 to 1) Xw 802, Y direction (0 to 1) 803, estimated item 804, and likelihood (0 to 1) Pw 805 as columns (columns) to store information (values).

In the weight sensor information, information corresponding to each column based on the measurement value of the weight sensor 300 is associated with each other and stored as information (record) in units of rows.

Specifically, #801 contains a row number. X-direction (0 to 1) Xw 802 contains the X-direction position Xw of the item acquisition event occurrence position. Y-direction (0 to 1) 803 contains the Y-direction position of the item acquisition event occurrence position. Estimated item 804 contains information (name of the item) indicating the picked up estimated item at the X-direction position Xw. Likelihood (0 to 1) Pw 805 contains the likelihood Pw of the picked up estimated item.

The TOF sensor determination unit 420 of the article identification device 400 calculates the TOF sensor information shown in FIG. 8B based on the position of a predetermined part of the user Us1 detected by the distance sensor 200a and the distance sensor 200b (the hand outstretched position in Example 1) and the item management information 440. The TOF sensor information includes #811 and X direction (0 to 1) Xt 812 as columns (columns) for storing information (values). The TOF sensor information contains the information corresponding to each column based on the information detected by the distance sensor 200a and the distance sensor 200b as information (records) in row units by mapping each other. In #811, a row number is stored. In X direction (0 to 1) Xt 812, a hand outstretched position is stored as an item picked up position Xt. Estimated item 813 contains information (name of the item) indicating the estimated item picked up at the item picked up position Xt.

In Example 1, the weight sensor information includes the information of row number 1, row number 2, and row number 3. The X-direction position Xw of the information in row number 1 is 0.55, the picked up estimated item is B, and the likelihood Pw is 0.8. The X-direction position Xw of the information in row number 2 is 0.80, the picked up estimated item is A, and the likelihood Pw is 0.6. The X-direction position Xw of the information in row number 3 is 0.20, and the picked up estimated item is C, and the likelihood Pw is 0.3.

The TOF sensor information includes the information on row number 1. The item picked up position Xt of the information in row number 1 is 0.65, and the estimated item picked up is A.

The item position determination unit (for integration) 430 of the article identification device 400 applies the weight sensor information and the TOF sensor information to Formula (1) to calculate the corrected likelihood information. That is, the item position determination unit (for integration) 430 calculates the correction likelihood Pnew for each picked up estimated item by Formula (1).

The corrected likelihood information includes #821, estimated item 822, correction likelihood (Pnew) 823, and Pnew 824 as columns (columns) for storing information (values). In the corrected likelihood information, the information corresponding to each column regarding calculation of the corrected likelihood Pnew is associated with each other and stored as information (record) in units of rows.

Specifically, #821 contains a row number. The estimated item 822 contains information indicating the picked up estimated item (name of the item). Correction likelihood (Pnew) 823 contains Formula (1) in which each variable is assigned a numerical value. Pnew 824 contains the value of the correction likelihood Pnew calculated by Formula (1).

Specifically describing the calculation method of the corrected likelihood information, the item position determination unit (for integration) 430 calculates the correction likelihood of row number 1 of the corrected likelihood information by Formula (1) from the information of row number 1 of the weight sensor information and the information of row number 1 of the TOF sensor information. The item position determination unit (for integration) 430 calculates the correction likelihood of row number 2 of the corrected likelihood information from the information of row number 2 of the weight sensor information and the information of row number 1 of the TOF sensor information using Formula (1). The item position determination unit (for integration) 430 calculates the correction likelihood of row number 3 of the corrected likelihood information by Formula (1) from the information of row number 3 of the weight sensor information and the information of row number 1 of the TOF sensor information.

In Example 1, the calculated corrected likelihood information includes the information in row number 1, the information in row number 2, and the information in row number 3. The picked up estimated item of the information in row number 1 is B, and the correction likelihood Pnew is 0.6. The information in row number 1 corresponds to the information when the user Us1 picked up item B. The picked up estimated item of the information in row number 2 is A, and the corrected likelihood Pnew is 0.3. The information in row number 2 corresponds to the information when the user Us1 picked up item A. The picked up estimated item of the information in row number 3 is C, and the corrected likelihood Pnew is −0.6. The information in row number 3 corresponds to the information when the user Us1 picked up item C.

The item position determination unit (for integration) 430 determines (identifies) the picked up estimated item with the highest correction likelihood Pnew as the picked up item from the shelf SB1 among the picked up estimated items. In Example 1, the item position determination unit (for integration) 430 determines item B as the picked up item because the correction likelihood Pnew of the picked up estimated item B is the highest.

In Example 1, the picked up estimated item with the highest likelihood of the picked up estimated item of the weight sensor information is the estimated item B, and the picked up estimated item with the highest likelihood of the picked up estimated item of the corrected likelihood information is the estimated item B. The picked up estimated items with the highest likelihood of each piece of information are identical.

### Example 2

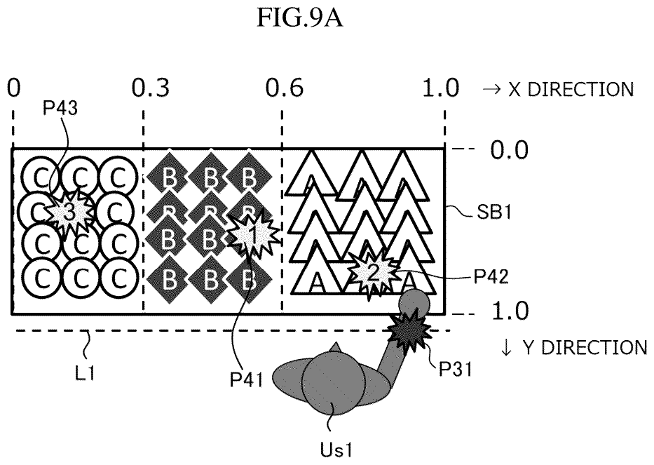

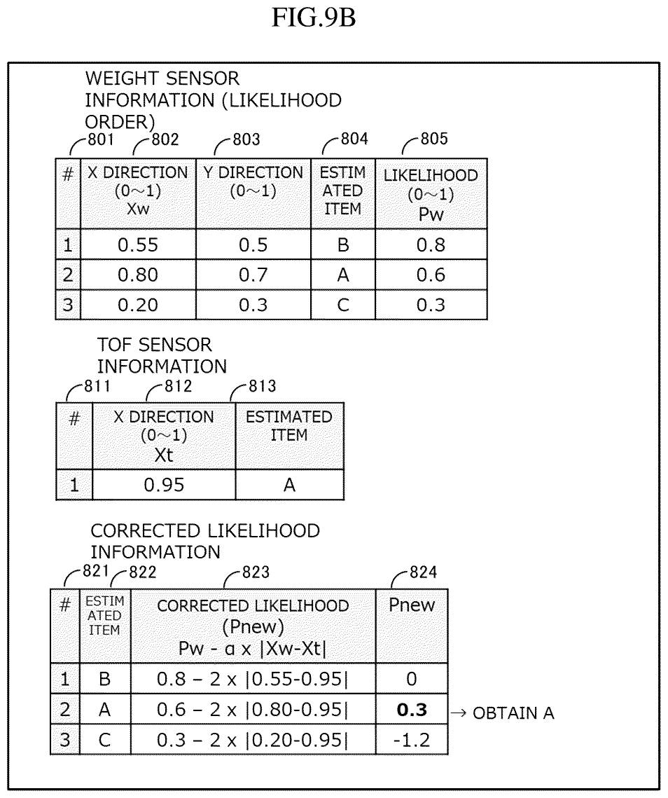

FIG. 9A and FIG. 9B are used to illustrate the specific Example 2 of the operation of the article identification device 400. FIG. 9A and FIG. 9B illustrate the Example 2 of the operation of the article identification device 400. As shown in FIG. 9A, assume a situation where the distance sensor 200a and the distance sensor 200b detect the hand outstretched position at position P31, the weight change (change in total weight and weight balance) is detected by the weight sensors 300, and an item acquisition event occurs at position P41, P42, and P43.

The item position determination unit (for shelf) 410 and the hand outstretched position determination unit 420 of the article identification device 400 calculate weight sensor information and the TOF sensor information as in Example 1.

In Example 2, the weight sensor information includes the information of row number 1, row number 2, and row number 3. The X-direction position Xw of the information in row number 1 is 0.55, the picked up estimated item is B, and the likelihood Pw is 0.8. The X-direction position Xw of the information in row number 2 is 0.80, the picked up estimated item is A, and the likelihood Pw is 0.6. The X-direction position Xw of the information in row number 3 is 0.20, the picked up estimated item is C, and the likelihood Pw is 0.3.

The TOF sensor information includes the information on row number 1. The item picked up position Xt of the information in row number 1 is 0.95, and the picked up estimated item is A.

The item position determination unit (for integration) 430 of the article identification device 400 applies the weight sensor information and the TOF sensor information to Formula (1) to calculate the corrected likelihood information. That is, the item position determination unit (for integration) 430 calculates the correction likelihood Pnew using Formula (1) for each picked up estimated item. The calculation method of the correction likelihood Pnew is the same as in Example 1.

In Example 2, the calculated corrected likelihood information includes the information in row number 1, the information in row number 2, and the information in row number 3. The picked up estimated item of the information in row number 1 is B, and the correction likelihood Pnew is 0. The information in row number 1 corresponds to the information when the user Us1 picked up item B. The picked up estimated item of the information in row number 2 is A, and the corrected likelihood Pnew is 0.3. The information in row number 2 corresponds to the information when the user Us1 picked up item A. The picked up estimated item of the information in row number 3 is C, and the corrected likelihood Pnew is −1.2. The information in row number 3 corresponds to the information when the user Us1 picked up item C.

The item position determination unit (for integration) 430 determines (identifies) the picked up estimated item with the highest correction likelihood Pnew as the picked up item from the shelf SB1 among the picked up estimated items. In Example 2, the item position determination unit (for integration) 430 determines item A as the picked up item because the correction likelihood Pnew of the picked up item A is the highest.

In Example 2, the picked up estimated item with the highest likelihood among the picked up estimated items of the weight sensor information is the estimated item B, and the picked up estimated item with the highest correction likelihood Pnew among the picked up estimated items of the corrected likelihood information is the estimated item A. That is, if the picked up item is identified based only on the weight sensor information as in the reference example, the picked up item is identified as item B, and the wrong item is identified as the picked up item. In contrast, in Example 2, the likelihood Pw of the weight sensor information is corrected and the picked up item is identified based on the corrected likelihood Pnew, thereby identifying the correct item A as the picked up item.

### Example 3

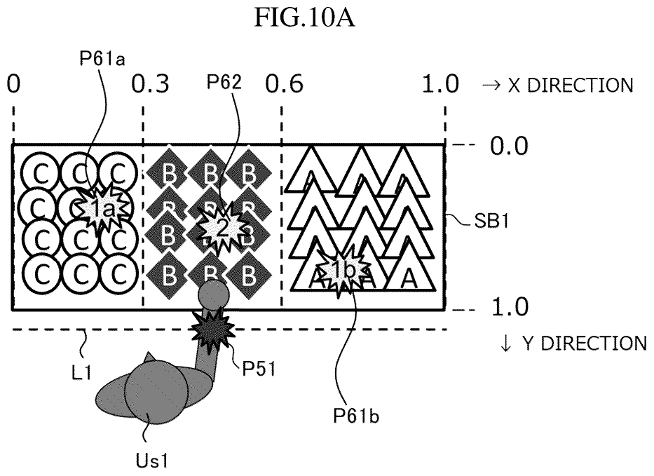

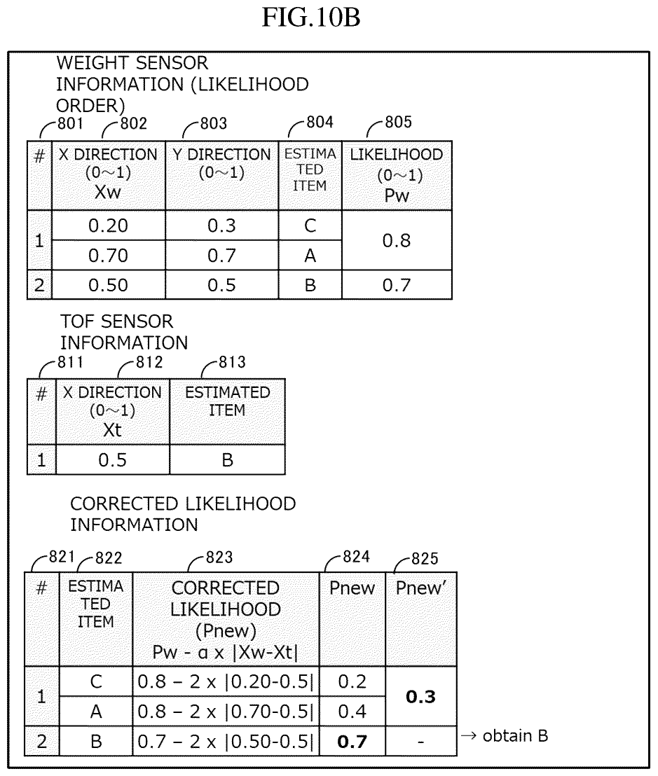

FIG. 10A and FIG. 10B illustrate the specific Example 3 of the operation of the article identification device 400. Assume a situation where the hand outstretched position is detected at position P51, a weight change (change in total weight and weight balance) is detected by the weight sensors 300, and an item acquisition event occurs at position P61a, position P61b, and position P62. Based on the weight change (change in total weight and weight balance), it is detected (estimated) that the item at position P61a and the item at position P61b were both picked up at the same time.

The item position determination unit (for shelf) 410 and the hand outstretched position determination unit 420 of the article identification device 400 obtain the weight sensor information and the TOF sensor information as in Example 1. The information on multiple items picked up at the same time (in this example, item C and item A) are combined into a single row number containing two rows of information.

In Example 3, the weight sensor information includes two rows of information, row number 1 and row number 2. The X-direction position Xw of the information in one of the rows of row number 1 is 0.20, the picked up estimated item is C, and the likelihood Pw is 0.8. The position Xw in the X direction of the information in the other row of Row 1 is 0.70, and the picked up estimated item is A, and the likelihood Pw is 0.8. The X-direction position Xw of the information in row number 2 is 0.5, the picked up estimated item is B, and the likelihood Pw is 0.7.

The TOF sensor information includes the information on row number 1. The item picked up position Xt of the information in row number 1 is 0.5, and the estimated item is B.

The item position determination unit (for integration) 430 of the article identification device 400 applies the weight sensor information and the TOF sensor information to Formula (1) to calculate the corrected likelihood information. That is, the item position determination unit (for integration) 430 calculates the correction likelihood Pnew for each picked up estimated item by Formula (1). Furthermore, the item position determination unit (for integration) 430 calculates the average Pnew′ (average correction likelihood Pnew′) of the correction likelihood Pnew of the picked up estimated item C and the estimated item A, which are estimated to have been picked up simultaneously. The corrected likelihood information further includes Pnew′ 825 as a column (column) for storing the information. In Pnew′ 825, the average Pnew′ of the correction likelihood Pnew is stored.

Specifically, the item position determination unit (for integration) 430 calculates the correction likelihood Pnew for each picked up estimated item using Formula (1). The item position determination unit (for integration) 430 calculates the correction likelihood Pnew of row number 1 of the corrected likelihood information by Formula (1) from the information of one row of row number 1 of the weight sensor information and the information of row number 1 of the TOF sensor information. The item position determination unit (for integration) 430 calculates the correction likelihood Pnew of the other row of the corrected likelihood information by Formula (1) from the information of the other row of row number 1 of the weight sensor information and the information of row number 1 of the TOF sensor information. The item position determination unit (for integration) 430 calculates the correction likelihood Pnew of row number 2 of the corrected likelihood information by Formula (1) from the information of row number 2 of the weight sensor information and row number 1 of the TOF sensor information. The item position determination unit (for integration) 430 calculates the average Pnew′ of the correction likelihoods Pnew of estimated item C and estimated item A by calculating the average Pnew′ of the correction likelihood Pnew of one row of row number 1 and the correction likelihoods Pnew of the other row of row number 1, and then stores the calculated average Pnew′ in the row of Pnew′ 825 corresponding to one row and the other row of row number 1.

In Example 3, the calculated corrected likelihood information includes information for row number 1, which contains two rows, and information for row number 2.

The picked up estimated item of the information in the first row of row number 1 is C. The correction likelihood Pnew is 0.2, and the average correction likelihood Pnew′ is 0.3. The information in one row of row number 1 corresponds to the information when the user Us1 picked up item C at the same time as A. The picked up estimated item in the other row of information in row 1 is A. The correction likelihood Pnew is 0.4, and the average correction likelihood Pnew′ is 0.3. The information in the other row of information in row number 1 corresponds to the information when the user Us1 picks up item A at the same time as C. The picked up estimated item in the information in row number 2 is B, and the correction likelihood Pnew is 0.7. The information in row number 2 corresponds to the case when the user Us1 picked up item B.

The item position determination unit (for integration) 430 determines (identifies) the picked up estimated item whose correction likelihood Pnew or average correction likelihood Pnew′ is the highest from among the picked up estimated items as the picked up item from the shelf SB1. In Example 3, the item position determination unit (for integration) 430 determines item B as the picked up item because the correction likelihood Pnew of the picked up estimated item B is the highest.

### Example 4

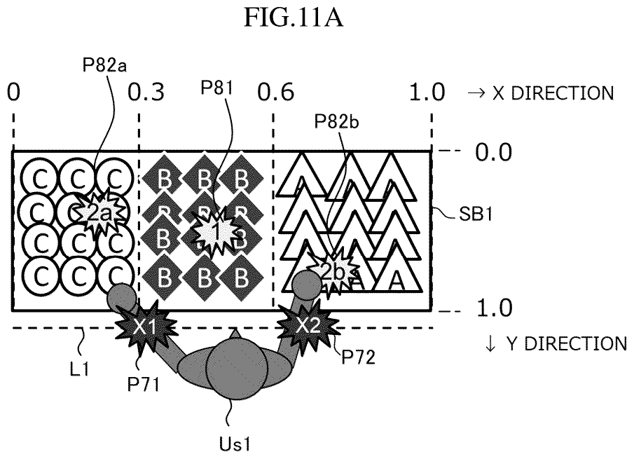

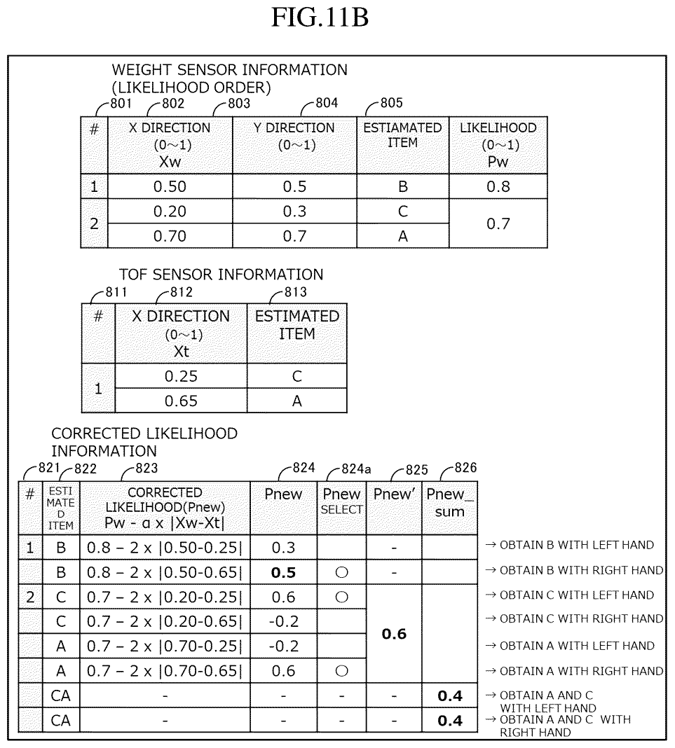

FIG. 11A and FIG. 11B illustrate the specific Example 4 of the operation of the article identification device 400. Assume a situation where the hand outstretched position is detected at positions P71 and P72, a weight change (change in total weight and weight balance) is detected by the weight sensors 300, and an item acquisition event occurs at positions P81, P82a, and P82b. Based on the weight change (change in total weight and weight balance), it is detected that the item at position P82a and the item at position P82b were picked up simultaneously.

The item position determination unit (for shelf) 410 and the hand outstretched position determination unit 420 of the article identification device 400 obtain the weight sensor information and the TOF sensor information shown in FIG. 11B, as in Example 1. The information about multiple items (in this example, items C and A) picked up at the same time is combined into one row number of information including two rows.

In Example 4, the weight sensor information includes the information in row number 1 and the information in row number 2, which contains two rows. The X direction position Xw of the information in row number 1 is 0.50, the picked up estimated item is B, and the likelihood Pw is 0.8. The X-direction position Xw of the information in one row of row number 2 is 0.20, the estimated picked up item is C, and the likelihood Pw is 0.7. The X-direction position Xw of the information in the other row of row number 2 is 0.7, the picked up estimated item is A, and the likelihood Pw is 0.7.

The TOF sensor information includes the information of row number 1 including two rows. The item picked up position Xt of the information in one of the rows of row number 1 is 0.25, and the estimated pickup item is C. The item picked up position Xt of the information in the other row of row number 1 is 0.65, and the estimated picked up item is A.

The item position determination unit (for integration) 430 of the article identification device 400 applies the weight sensor information and the TOF sensor information to Formula (1) to calculate the corrected likelihood information. The corrected likelihood information further includes Pnew select 824a and Pnew sum 826 as columns (columns) for storing information. Pnew select 824a contains information indicating whether the correction likelihood Pnew for that row is selected or not. Pnew sum 826 contains Pnew_sum that is the sum of the correction likelihood Pnew.

Specifically, the item position determination unit (for integration) 430 calculates the correction likelihood Pnew for each picked up estimated item using Formula (1). The item position determination unit (for integration) 430 calculates the correction likelihood Pnew for the one row of the corrected likelihood information by Formula (1) from the information in row number 1 of the weight sensor information and the information in row number 1 of the TOF sensor information. The item position determination unit (for integration) 430 calculates the correction likelihood Pnew of the other row of the corrected likelihood information by Formula (1) from the information of one row of the row number 1 of the weight sensor information and the other row of the row number 1 of the TOF sensor information. Then, the item position determination unit (for integration) 430 selects the larger of the correction likelihood Pnew of one row of the corrected likelihood information row number 1 and the correction likelihood Pnew of the other row of the corrected likelihood information row number 1, and displays information “o(=correct)” in this example” indicating that the larger correction likelihood is selected, as Pnew select 824a in the row corresponding to the selected correction likelihood Pnew in Pnew select 824a.

The item position determination unit (for integration) 430 calculates the correction likelihood Pnew of the first row of the corrected likelihood information, row number 2, by Formula (1) from the information in one row of the weight sensor information, row number 2, and the information in one row of the TOF sensor information, row number 1. The item position determination unit (for integration) 430 calculates the correction likelihood Pnew of the second row of the corrected likelihood information, row number 2, by Formula (1) from the information of the one row of the weight sensor information, row number 2, and the other row of the TOF sensor information, row number 1. Then, the item position determination unit (for integration) 430 selects the larger of the correction likelihood Pnew of the first row of the corrected likelihood information row number 2 and the correction likelihood Pnew of the second row of the corrected likelihood information row number 2, and displays the information “C)(=correct) in this example” indicating that the larger correction likelihood is selected, as shown in Pnew select 824a corresponding to the selected correction likelihood Pnew.

The item position determination unit (for integration) 430 calculates the correction likelihood Pnew of the third row of row number 2 of the corrected likelihood information by Formula (1) from the information in the other rows of row number 2 of the weight sensor information, and the information in the one row of row number 1 of the TOF sensor information. The item position determination unit (for integration) 430 calculates the correction likelihood Pnew of the fourth row of row number 2 of the corrected likelihood information by Formula (1) from the information of the other row of row number 2 of the weight sensor information and the other row of row number 1 of the TOF sensor information. Then, the item position determination unit (for integration) 430 selects the larger of the correction likelihood Pnew of the third row of row number 2 of the corrected likelihood information and the correction likelihood Pnew of the fourth row of row number 2 of the corrected likelihood information, and stores the information “in this example, “◯ (=correct)” indicating that the larger correction likelihood Pnew has been selected in the row corresponding to the selected correction likelihood Pnew.

Furthermore, the item position determination unit (for integration) 430 calculates the average Pnew′ of the correction likelihoods Pnew of the estimated item C and the estimated item A, which are estimated to have been picked up simultaneously. The item position determination unit (for integration) 430 calculates the average Pnew′ of the correction likelihoods Pnew of the estimated item C and the estimated item A by calculating the average Pnew′ of the selected correction likelihoods Pnew, and stores the average Pnew′ of the correction likelihoods Pnew′ of the estimated item C and the estimated item A in the row of Pnew′ 825 corresponding to the first through fourth rows of Pnew select 824a.

Furthermore, the item position determination unit (for integration) 430 calculates the sum Pnew_sum of the corrected likelihood Pnew of the estimated item C and the estimated item A, which are estimated to have been picked up by the same hand at the same time. The item position determination unit (for integration) 430 calculates the sum Pnew_sum of the corrected likelihoods Pnew of the information in the first row of row number 2 and the corrected likelihood Pnew of the information in the third row of row number 2, to thereby calculate the sum Pnew_sum of the corrected likelihoods Pnew of estimated item C and estimated item A, which were picked up by the left hand at the same time. The item position determination unit (for integration) 430 stores the calculated sum Pnew in Pnew_sum 826 in the fifth row of row number 2.

The item position determination unit (for integration) 430 calculates the sum Pnew_sum of the corrected likelihood Pnew of the information in the second row of row number 2 and the corrected likelihood Pnew of the information in the fourth row of row number 2, to thereby calculates Pnew_sum of the corrected likelihoods Pnew of the estimated item C and the estimated item A that estimated were picked up by the right hand at the same time. The item position determination unit (for integration) 430 stores the calculated Pnew_sum in Pnew_sum 826 in the sixth row of row number 2.

In Example 4, the calculated corrected likelihood information includes information for row number 1, which contains two rows, and information for row number 2, which contains six rows.

The picked up estimated item of the information in the first row of row number 1 is B, and the corrected likelihood Pnew is 0.3. The information in one row of row number 1 corresponds to the information when the user Us1 picks up item B with his left hand. The picked up estimated item of the information in the other row of row number 1 is B, and the corrected likelihood Pnew is 0.5. The information in the other row of row number 1 corresponds to the information when the user Us1 picked up item B with his right hand.

The picked up estimated item of the information in the first row of row number 2 is C, the correction likelihood Pnew is 0.6, and the average correction likelihood Pnew′ is 0.6. The information in the first row of row number 2 corresponds to the information when the user Us1 picks up item C with his left hand.

The picked up estimated item of the information in the second row of row number 2 is C, the correction likelihood Pnew is −0.2, and the average correction likelihood Pnew′ is 0.6. The information in the second row of row number 2 corresponds to the information when the user Us1 picks up item C with his right hand.

The picked up estimated item of the information in the third row of row number 2 is A, the correction likelihood Pnew is −0.2, and the average correction likelihood Pnew′ is 0.6. The information in the third row of line 2 corresponds to the information when the user Us1 picks up item A with his left hand.

The picked up estimated item of the information in the fourth row of row number 2 is A, the correction likelihood Pnew is 0.6, and the average correction likelihood Pnew′ is 0.6. The information in the fourth row of row number 2 corresponds to the information when the user Us1 picks up item A with his right hand.

The picked up estimated items in the information in the fifth row of row number 2 are C and A, and the Pnew_sum of the sum of the corrected likelihood Pnew is 0.4 (=0.6+(−0.2)). The information in the fifth row of row number 2 corresponds to the information when the user Us1 picks up items C and A with his left hand.

The picked up estimated items of the information in the sixth row of row number 2 are C and A. Pnew_sum of the sum of the corrected likelihood Pnew is 0.4 (=0.6+(−0.2)). The information in the sixth row of row number 2 corresponds to the information when the user Us1 picks up items C and A with his right hand.

The item position determination unit (for integration) 430 determines (identifies) the picked up estimated item having the highest likelihood among the picked up estimated items in the correction likelihood Pnew, the average correction likelihood Pnew′ and the sum Pnew_sum of the correction likelihood Pnew as the picked up item from the shelf SB1. In Example 4, the item position determination unit (for integration) 430 determines item A and item C as the picked up items because the average corrected likelihood Pnew′ of the picked up item A and the picked up item C is the highest.

### Example 5

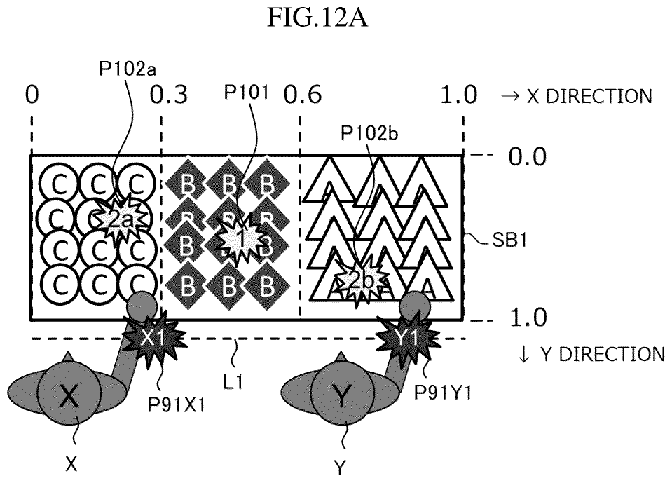

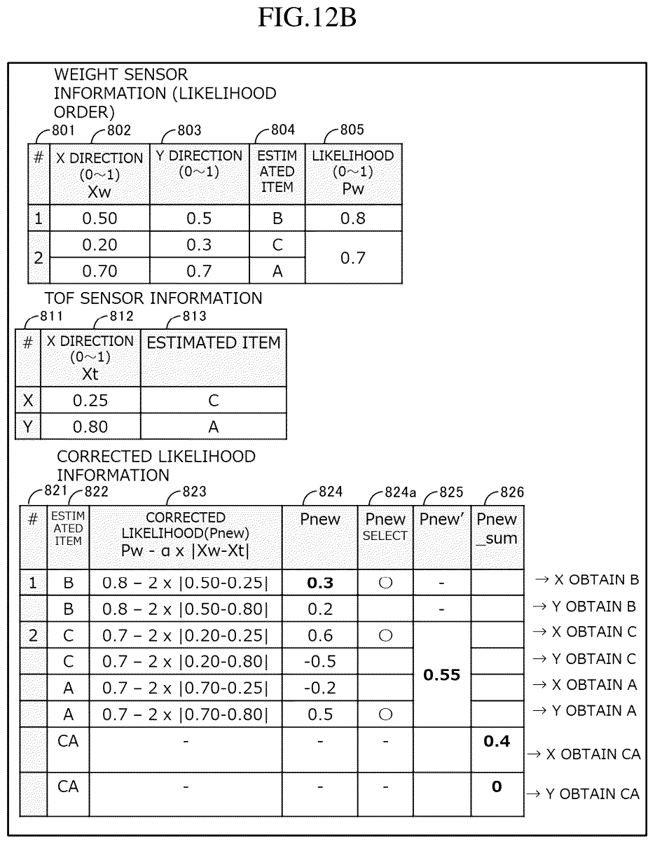

FIG. 12A and FIG. 12B illustrate the specific Example 5 of the operation of the article identification device 400. As shown in FIG. 12A, the hand outstretched position of a user X is detected at position P91X1 and the hand outstretched position of a user Y is detected at position P91Y1 with the distance sensor 200a and the distance sensor 200b. Assume a situation where a weight change (change in total weight and weight balance) is detected by the weight sensor 300 and an item acquisition event occurs at position P101, position P102a, and position P102b. Based on the weight change (change in total weight and weight balance), it is detected that the items were acquired at the same time at position P102a and position 102b.

The item position determination unit (for shelf) 410 and the hand outstretched position determination unit 420 of the article identification device 400 obtain the weight sensor information and the TOF sensor information shown in FIG. 12B, as in Example 1. The information on multiple items (in this example, items C and A) picked up at the same time is combined into one row number of information including two rows.

In Example 5, the weight sensor information includes row number 1 information and row number 2 information including two rows.

The X-direction position Xw of the information in row number 1 is 0.50, the picked up estimated item is B, and the likelihood Pw is 0.8. The position Xw in the X-direction of the information in the first row of row number 2 is 0.20, the picked up estimated item is C, and the likelihood Pw is 0.7. The position Xw in the X direction of the information in the other row of row number 2 is 0.70, the picked up estimated item is A, and the likelihood Pw is 0.7.

The TOF sensor information includes information for row number X and row number Y. The item picked up position Xt of the information of row number X is 0.25 and the picked up estimated item is C. The information of row number X is the information obtained based on the distance data (point cloud) of the user X. The information of row number Y has an item picked up position Xt of 0.80. The information of row number Y is the information obtained based on the distance data (point cloud) of the user Y.

The article identification device 400 applies the weight sensor information and the TOF sensor information to Formula (1) to calculate the corrected likelihood information. Specifically, the item position determination unit (for integration) 430 of the article identification device 400 calculates the correction likelihood Pnew for each picked up estimated item using Formula (1). The item position determination unit (for integration) 430 calculates the correction likelihood Pnew of one row of row number 1 of the corrected likelihood information using Formula (1) from the information of row number 1 of the weight sensor information and the information of row number X of the TOF sensor information. The item position determination unit (for integration) 430 calculates the correction likelihood Pnew of the other row of the row number 1 of the corrected likelihood information from the information of the row number 1 of the weight sensor information, and the information of the row number Y of the TOF sensor information, using Formula (1). Then, the item position determination unit (for integration) 430 selects the larger of the correction likelihood Pnew of one row of row number 1 of the corrected likelihood information and the correction likelihood Pnew of the other row of row number 1 of the corrected likelihood information, and stores the information “◯ (=correct) in this example” indicating that the larger correction likelihood Pnew is selected in the row of Pnew select 824a corresponding to the selected correction likelihood Pnew.

The item position determination unit (for integration) 430 calculates the correction likelihood Pnew of the first row of the corrected likelihood information row number 2 by Formula (1) from the information of one row of row number 2 of the weight sensor information and the information of row number X of the TOF sensor information. The item position determination unit (for integration) 430 calculates the correction likelihood Pnew of the second row of row number 2 of the corrected likelihood information from the information of one row of row number 2 of the weight sensor information and the information of row number Y of the TOF sensor information using Formula (1). The item position determination unit (for integration) 430 selects the larger of the correction likelihood of the first row of row number 2 of the corrected likelihood information of row number 2 and the correction likelihood Pnew of the second row of row number 2 of the corrected likelihood information, and stores information “◯ (=correct) in this example” indicating that the larger correction likelihood Pnew is selected in the row of the Pnew select 824a corresponding to the selected correction likelihood Pnew.

The item position determination unit (for integration) 430 calculates the correction likelihood Pnew of the third row of row number 2 of the corrected likelihood information by Formula (1) from the information of the other rows of row number 2 of the weight sensor information and the information of row number X of the TOF sensor information. The item position determination unit (for integration) 430 calculates the correction likelihood Pnew of the fourth row of row number 2 of the corrected likelihood information by Formula (1) from the information of the other rows of row number 2 of the weight sensor information and row number Y of the TOF sensor information. Then, the item position determination unit (for integration) 430 selects the larger of the correction likelihood Pnew of the third row of row number 2 of the corrected likelihood information and the correction likelihood Pnew of the fourth row of row number 2 of the corrected likelihood information, and stores the information “C)(=correct) in this example” indicating that the larger correction likelihood is selected in the row corresponding to the selected correction likelihood Pnew of Pnew select 824a.

Furthermore, the item position determination unit (for integration) 430 calculates the average Pnew′ of the correction likelihoods Pnew of the estimated item C and the estimated item A, which are estimated to have been picked up simultaneously. The item position determination unit (for integration) 430 calculates the average Pnew′ of the correction likelihoods Pnew that has been selected to thereby calculate the average Pnew′ of the correction likelihoods Pnew of the estimated item C and the estimated item A and stores the calculated average Pnew′ in the rows corresponding to the first through fourth rows of Pnew select 824a.

Furthermore, the item position determination unit (for integration) 430 calculates the sum Pnew_sum of the corrected likelihood Pnew of the estimated item C and the estimated item A, which are estimated to have been picked up by the user X or the user Y at the same time. The item position determination unit (for integration) 430 calculates the sum Pnew_sum of the corrected likelihood Pnew of the information in the first row of row number 2 and the corrected likelihood Pnew of the information in the third row of row number 2 to thereby calculate Pnew_sum of the sum of the corrected likelihood Pnew of the estimated item C and the estimated item A estimated to have been picked up by the user X at the same time and stores the calculated Pnew_sum in Pnew_sum 826 of the fifth row of row number 2.

The item position determination unit (for integration) 430 calculates the sum Pnew_sum of the corrected likelihood Pnew of the information in the second row of row number 2 and the corrected likelihood Pnew of the information in the fourth row of row number 2 to thereby calculate Pnew_sum of the sum of the corrected likelihood Pnew of the estimated item C and the estimated item A estimated to have been simultaneously picked up by the user Y and stores in Pnew_sum 826 in the sixth row of row number 2.

In Example 5, the calculated corrected likelihood information includes information of row number 1 including two rows, and information of row number 2 including six rows.

The picked up estimated item of the information in the first row of row number 1 is B, and the corrected likelihood Pnew is 0.3. The information in one row of row number 1 corresponds to the information when the user X picked up item B.

The picked up estimated item of the information in the other row of row number 1 is B, and the corrected likelihood Pnew is 0.2. The information in the other row of row number 1 corresponds to the information when the user Y picked up item B.

The picked up estimated item of the information in the first row of row number 2 is C, the correction likelihood is 0.6, and the average correction likelihood Pnew′ is 0.55. The information in the first row of row number 2 corresponds to the information when the user X picked up item C at the same time as item A.

The picked up estimated item in the second row of information in row number 2 is C. The correction likelihood Pnew is −0.5 and the average correction likelihood Pnew′ is 0.55. The information in the second row of number 2 corresponds to the information when the user Y picked up item C at the same time as item A.

The picked up estimated item of the information in the third row of row number 2 is A. The correction likelihood Pnew is −0.2 and the average correction likelihood Pnew′ is 0.55. The information in the third row of row number 2 corresponds to the information when the user X picked up item A at the same time as item C.

The picked up estimated item of the information in the fourth row of row number 2 is A. The correction likelihood Pnew is 0.5, and the average correction likelihood Pnew′ is 0.55. The information in the fourth row of row number 2 corresponds to the information when the user Y picked up item A at the same time as item C.

The picked up estimated items in the information in the fifth row of row number 2 are C and A. Pnew_sum of the sum of the corrected likelihood Pnew is 0.4 (=0.6+(−0.2)). The information in the fifth row of row number 2 corresponds to the information when the user X picked up items C and A.

The picked up estimated items of the information in the sixth row of row number 2 are C and A. Pnew_sum of the sum of the corrected likelihood Pnew is 0 (=0.5+(−0.5)). The information in the sixth row of row number 2 corresponds to the information when the user Y picked up the items C and A.

The item position determination unit (for integration) 430 determines (identifies) the picked up estimated item having the highest likelihood among the correction likelihood Pnew, the average correction likelihood Pnew′ and the sum of the correction likelihood as the picked up item picked up from the shelf SB1 from among the picked up estimated items. In specific example 5, since the average correction likelihood Pnew′ of the picked up estimated item A and the picked up estimated item C are the highest, the item position determination unit (for integration) 430 determines item A and item C as the picked up item. Furthermore, the item position determination unit (for integration) 430 determines item C as the picked up item of the user X and item A as the picked up item of the user Y based on the row from which the correction likelihood Pnew is selected.

<Specific Operation>

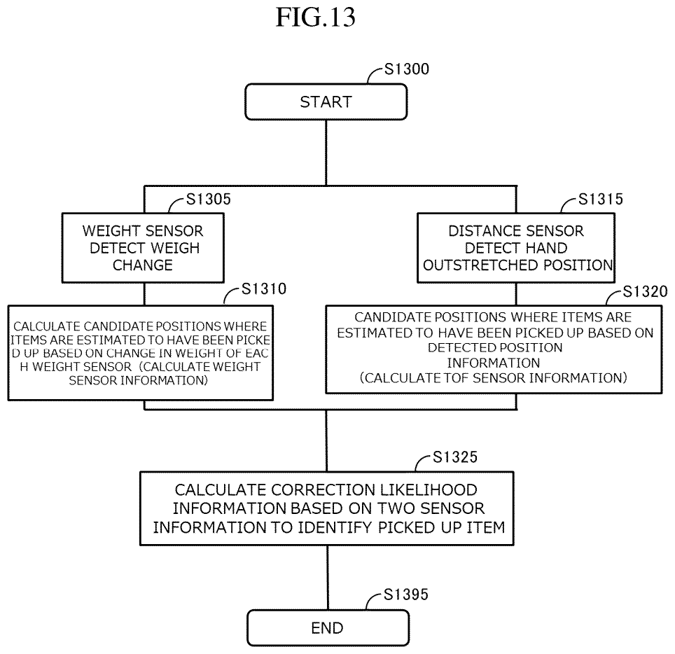

FIG. 13 is a flowchart showing the processing flow executed by the article identification system. The system starts processing from S1300 and executes in parallel the processes of S1305 and S1310, and S1315 and S1320, described below.

S1305: The weight sensor 300 detects weight change.

S1310: The item position determination unit (for shelf) 410 of the article identification device 400 determines some candidate positions (i.e., item acquisition event occurrence positions (X direction position Xw)) of picked up estimated items where the items are estimated to have been picked up based on the measurements of each weight sensor 300 and the item management information 400. That is, the item position determination unit (for shelf) 410 calculates the weight sensor information described above.

S1315: The distance sensor 200a and the distance sensor 200b detect the hand outstretched position.

S1320: The hand outstretched position determination unit 420 of the article identification device 400 calculates several candidates for the picked up estimated item position (i.e., the item picked up position Xt) at which the item is estimated to have been picked up from the detected position information and the article management information 440. That is, the hand outstretched position determination unit 420 calculates the TOF sensor information described above.

The article identification system then performs S1325 described below, and then proceeds to S1395 to temporarily terminate this process flow.

S1325: The item position determination unit (for integration) 430 of the article identification device 400 calculates the corrected likelihood information from the two sensor information (the weight sensor information and the TOF sensor information) and determines (identifies) the item picked up based on the corrected likelihood information. The details of the process in S1325 are described below.

<S1325>

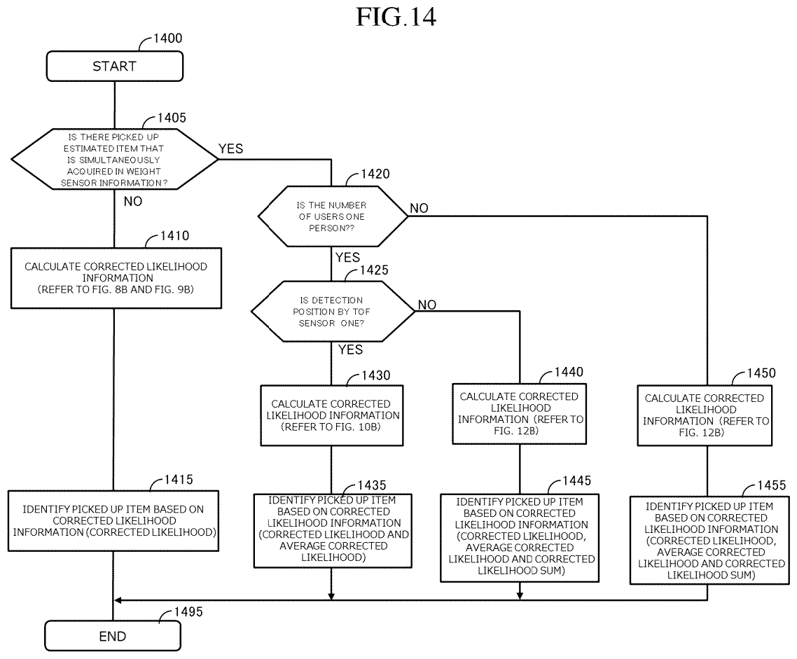

Details of the processing of S1325 described above will be described. FIG. 14 is a flowchart showing a processing flow executed by the item position determination unit (for integration) 430 of the article identification device 400. The item position determination unit (for integration) 430 starts the processing from step 1400 and proceeds to step 1405 to determine whether or not there is a picked up estimated item that is simultaneously acquired in the weight sensor information.

When there is no item to be picked up estimated simultaneously acquired in the weight sensor information, the item position determination unit (for integration) 430 makes a “NO” determination at step 1405 and executes steps 1410 and 1415 described below in sequence, then proceeds to step 1495 to temporarily terminate this processing flow.

Step 1410: The item position determination unit (for integration) 430 calculates the corrected likelihood information using the calculation method described above with reference to FIG. 8B (FIG. 9B).

Step 1415: The item position determination unit (for integration) 430 identifies the picked up estimated item with the highest correction likelihood Pnew as the picked up item based on the corrected likelihood information.

When there is a picked up estimated item that is simultaneously acquired in the weight sensor information, the item position determination unit (for integration) 430 makes a “YES” determination at step 1405 and proceeds to step 1420 to determine whether the number of users is one or not based on the TOF sensor information.

When the number of users is one, the item position determination unit (for integration) 430 makes a “YES” determination at step 1420 and proceeds to step 1425 to determine whether there is only one hand outstretched detection position (item picked up position Xt) included in the TOF sensor information.

When there is only one hand outstretched position (item picked up position Xt) included in the TOF sensor information, the item position determination unit (for integration) 430 makes a “YES” determination at step 1425 and performs steps 1430 and 1435 described below in sequence, then proceeds to step 1495 to temporarily terminate this processing flow.

Step 1430: The item position determination unit (for integration) 430 calculates the corrected likelihood information using the calculation method described above with reference to FIG. 10B.

Step 1435: The item position determination unit (for integration) 430 identifies the picked up item based on the corrected likelihood Pnew and the average likelihood, as described above.

When there are two or more hand outstretched detection positions (item picked up position Xt) included in the TOF sensor information, the item position determination unit (for integration) 430 makes a “NO” determination at step 1425 and performs steps 1440 and 1445 described below in sequence, then proceeds to step 1495 to temporarily terminate this processing flow.

Step 1440: The item position determination unit (for integration) 430 calculates the corrected likelihood information using the calculation method described above with reference to FIG. 11B.

Step 1445: The item position determination unit (for integration) 430 identifies the picked up estimated item with the highest likelihood among the correction likelihood Pnew, the average correction likelihood Pnew′ and the sum of correction likelihoods Pnew_sum as the picked up item based on the corrected likelihood information as described above.

When the number of the users is two or more at step 1420 described above, the item position determination unit (for integration) 430 makes a “NO” determination at step 1420, executes steps 1450 and 1455 described below in sequence, and then proceeds to step 1495 to temporarily terminate this processing flow.

Step 1450: The item position determination unit (for integration) 430 calculates the corrected likelihood information using the calculation method described above with reference to FIG. 12B.

Step 1455: As described above, the item position determination unit (for integration) 430 identifies the picked up estimated item having the highest likelihood among the correction likelihood Pnew, the average likelihood and the sum Pnew_sum of the correction likelihood Pnew as the picked up item, based on the corrected likelihood information. Further, the item position determination unit (for integration) 430 identifies the user of the identified picked up item.

<Effect>

As explained above, the article identification system according to the first embodiment of the present invention calculates a correction likelihood Pnew by correcting the likelihood Pw of the picked up estimated item using the X-direction position Xw based on the measurements of the weight sensor 300, and the picked up position Xt detected by the distance sensor 200a and the distance sensor 200b. The article identification system determines (identifies) the picked up item based on the corrected likelihood Pnew. This allows the article identification system to accurately identify items that are simultaneously picked up from different positions on the same shelf SB.

### Modified Example 1

In the first embodiment above, the article identification device 400 may weight the likelihood Pw by multiplying each likelihood Pw of the weight sensor information by a weight factor, and calculate the corrected likelihood Pnew using the likelihood after weighting (by substituting it into Formula (1)).

### Modified Example 2

In the first embodiment above, when the highest likelihood Pw of each of the likelihoods Pw of the weight sensor information is higher than a predetermined threshold likelihood, the article identification device 400 may determine (identify) the item with the highest likelihood Pw as the picked up item picked up from the shelf SB without considering the correction likelihood Pnew.

### Modified Example 3

In the first embodiment above, when there is an picked up estimated item for which the item acquisition event occurrence position could not be obtained, the article identification device 400 may consider the X-direction position Xw of the item acquisition event occurrence position of the picked up estimated item to be a predetermined position based on where the item is located. For example, when the picked up estimated item that failed to obtain an item acquisition event occurrence position is item C, then since item C is located in a range of X-direction positions between 0 and 0.3, based on this range, the X-direction position Xw of the item acquisition event occurrence position for that picked up estimated item may be calculated to be 0.15.

### Modified Example 4

In the first embodiment described above, when the article identification device 400 is unable to obtain the item picked up position Xt due to the fact that the hand outstretched position could not be detected by the distance sensor 200a and the distance sensor 200b, it may not calculate the correction likelihood Pnew, but may estimate the item picked up from shelf SB based on only the likelihood Pw of the weight sensor information.

### Modified Example 5

In the first embodiment above, when the article identification device 400 cannot detect the hand outstretched position by the distance sensor 200a and the distance sensor 200b, but can detect the position where the head of the user US1 appears on the virtual screen, the detectable head position may be used as the item picked up position Xt and the correction likelihood Pnew may be calculated. In this case, the article identification device 400 may calculate the correction likelihood Pnew by making the weighting factor of Formula (1) smaller than usual (e.g., smaller than when the hand outstretched position can be detected).

### Modified Example 6

In the first embodiment above, the article identification device 400 may determine the value of the weighting factor in Formula (1) by machine learning. For example, the optimal weighting factor may be determined by machine learning using a number of weight sensor information and the TOF sensor information (training data) when the correct answer (correct item to be picked up) is known.

### Modified Example 7

In the first embodiment above, the article identification device 400 may set the weighting factor of Formula (1) to be larger the greater the degree of importance to be given to the results of the distance sensor 200a and the distance sensor 200b in identifying the picked up item.

### Second Embodiment

The article identification system according to the second embodiment of the present invention will be described. The article identification system according to the second embodiment of the present invention differs from the article identification system according to the first embodiment only in the following points.

The article identification device 400 calculates the range of possible item picked up in the X direction based on the item picked up position Xt detected using the distance sensor 200a and the distance sensor 200b. The article identification device 400 identifies the picked up item based on the item picked up possibility range and the likelihood Pw of the weight sensor information.

The following explanation focuses on these differences.

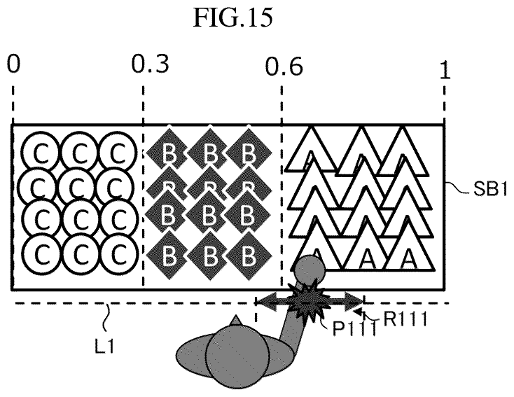

FIG. 15 illustrates the operation of the article identification device 400. As shown in FIG. 15, when the article identification device 400 obtains the position P111 as the item picked up position Xt, it sets the item picked up possibility range R111 based on the position P111. Based on the item picked up possibility range R111, the article identification device 400 excludes from the item picked up candidates the range of articles that are not likely to be picked up. For example, in this example, items A and B are likely to be picked up, while items C are not likely to be picked up, so items C are excluded from the items picked up candidates. The article identification device 400 determines the article with the highest likelihood Pw as the item picked up from the shelf SB1 from among the items A and B from which the item C is excluded, based on the likelihood Pw of each picked up estimated item of the weight sensor information.

<Effect>

As explained above, the article identification system according to the second embodiment of the present invention, as in the first embodiment, can accurately identify item picked up at the same time from different positions on the same shelf SB.

### Third Embodiment

This section describes the article identification system according to the third embodiment of the present invention. The article identification system according to the third embodiment of the present invention differs from the article identification system of the first embodiment only in the following points. The article identification device 400 calculates the item picked up possibility range in the X direction based on the item picked up position Xt detected using the distance sensor 200a and the distance sensor 200b and the X direction position Xw of the item picked up event occurrence position detected using the weight sensor 300. The article identification device 400 identifies the item to be picked up based on the item picked up possibility range and the likelihood Pw of the weight sensor information.

The following explanation focuses on these differences.

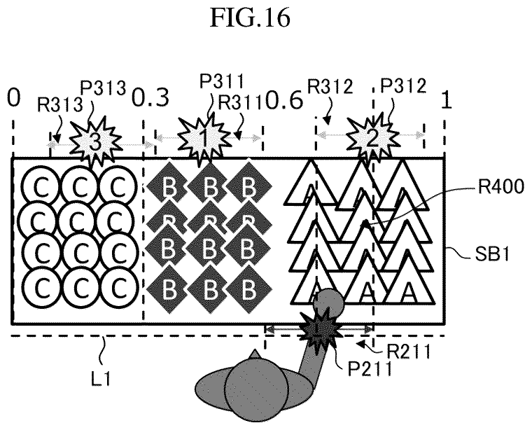

FIG. 16 illustrates the operation of the article identification device 400. As shown in FIG. 16, when the article identification device 400 obtains the position P211 as the item picked up position Xt, it sets the first item picked up possibility candidate range R211 based on the position P211. When the article identification device 400 obtains position P311, position P312, and position P313 as the X-direction position Xw of the item picked up event occurrence position, it sets the second item picked up possibility candidate range R311 based on position P311, sets the second item picked up possibility candidate range R312 based on position P312, and sets the third item picked up possibility candidate range R313 based on the position P313.

The article identification device 400 sets the range where the first item picked up possibility candidate range R211 and the second item picked up possibility candidate ranges R311 to R313 overlap in the Y direction as the item picked up possibility range R400.

The article identification device 400 excludes from the candidate for item picked up a range of items that are not likely to be picked up based on the item picked up possibility range R400. For example, in this example, since item A is likely to be picked up, while item B and item C are not likely to be picked up, item B and item C are excluded from the item picked up candidates. The article identification device 400 determines item A, from which item B and item C are excluded, as the item to have been picked up from the shelf SB1. If there are multiple remaining items after the items are excluded, the item with the highest likelihood Pw is identified as the picked up item from the shelf SB1 based on the likelihood Pw of each picked up estimated item in the weight sensor information.

<Effect>

As explained above, the article identification system according to the third embodiment of the present invention, as in the first embodiment, can accurately identify item picked up at the same time from different positions on the same shelf SB.

### Other Modified Examples

The present invention is not limited to each of the above embodiments and each of the above modified examples, and various modified examples may be employed within the scope of the present invention. Furthermore, each of the above embodiments and each of the above modified example can be combined with each other as long as they do not depart from the scope of the present invention.

In each of the above embodiments and each of the above modified examples, when determining the likelihood Pw based on the measurements detected by the weight sensor 300, the rate at which the items are purchased and whether the items are subject to a sale or discount may be considered. In each of the above embodiments and each of the above modified examples, when determining the likelihood Pw based on the measured measurements detected by the weight sensor 300, the presumption that the target item has the same or similar attributes as other items located in close proximity to each other may be considered. In addition, in the above embodiment, when determining the likelihood Pw, the past history of the likelihood Pw and its hit or miss results may be considered. Further, in the above embodiment, when determining the likelihood Pw based on the weight change of the shelf SB detected by the weight sensor 300, the likelihood Pw may be determined using methods such as machine learning, linear regression, logistic regression, decision tree analysis, support vector machine, etc.

The present invention can also be configured as follows.

[1]

An article identification method to be performed using a weight sensor that measures a weight of an article, the weight sensor being installed on a shelf on which the article is placed;
a distance sensor that includes the shelf and a predetermined area in front of the shelf in a measurement range and measures a distance to an object to be measured that is present in the measurement range; and
an article identification device including an information processing device that acquires weight measurement data that is the weight measured with the weight sensor, and distance data that are the distance representing a person present within the measurement range measured with the distance sensor,
the article identification method comprising:
estimating, based on the weight measurement data when the article is picked up from the shelf, the article picked up from the shelf;
calculating, for each of a plurality of picked up estimated articles, a first article picked up position that is an estimated picked up position of the picked up estimated article and a degree of accuracy indicating a degree of correctness of estimation of the picked up estimated article;
obtaining, based on the distance data of the person, a second article picked up position based on a position of a predetermined part of the person when the person picks up the article from the shelf;
calculating a corrected accuracy by correcting the accuracy for each of the picked up estimated articles based on the first article picked up position and the second article picked up position; and
identifying, based on the corrected accuracy, one or more picked up articles that are picked up from the shelf from among the picked up estimated articles.

[2]

A non-transitory computer-readable storage medium storing a computer-executable program for execution by a computer using:
weight measurement data obtained by a weight sensor that measures a weight of an article, the weight sensor being installed on a shelf on which the article is placed; and
distance data obtained by distance sensor that includes the shelf and a predetermined area in front of the shelf in a measurement range and measures a distance to an object to be measured that is present in the measurement range, the distance data being a distance representing a person present within the measurement range measured with the distance sensor,
the program comprising instructions for:
estimating, based on the weight measurement data when the article is picked up from the shelf, the article picked up from the shelf;
calculating, for each of a plurality of picked up estimated articles, a first article picked up position that is an estimated picked up position of the picked up estimated article and a degree of accuracy indicating a degree of correctness of estimation of the picked up estimated article;
obtaining, based on the distance data of the person, a second article picked up position based on a position of a predetermined part of the person when the person picks up the article from the shelf;
calculating a corrected accuracy by correcting the accuracy for each of the picked up estimated articles based on the first article picked up position and the second article picked up position; and
identifying, based on the corrected accuracy, one or more picked up articles that are picked up from the shelf from among the picked up estimated articles.

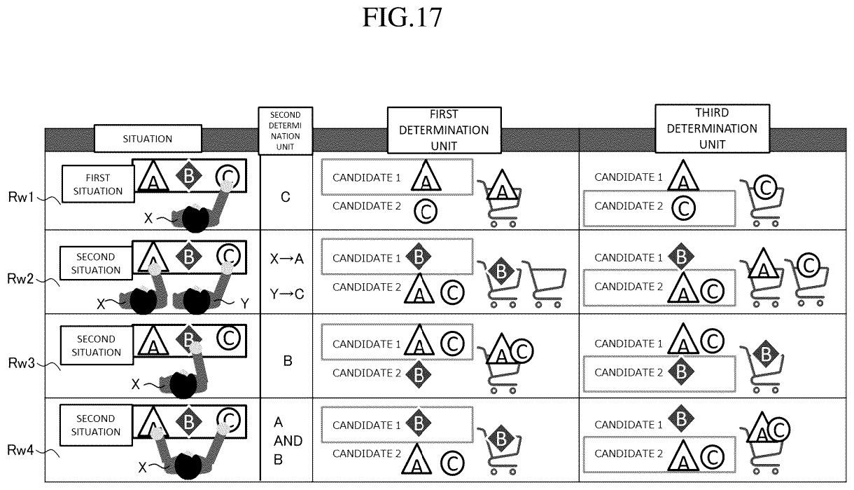

The following [3] through [7] article acquisition determination systems are explained with reference to FIG. 17.

[3]

An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
in a first situation (refer to row Rw1 in FIG. 17), where a first article (refer to B in FIG. 17) is placed in a first region of the shelf in the center of the shelf in one direction, a second region and a third region flanking the first region on both sides in the one direction, a second article (refer to A in FIG. 17) is placed in the second region, and a third article (refer to C in FIG. 17) is placed in the third region,
as shown in row Rw1, the first determination unit determines that the plurality of candidate articles includes one second article (A) and one third article (C), and that the most valid candidate article is the one second article (A) and the next most valid candidate article is the one third article (C), and
when the second determination unit determines that the first person (refer to X in FIG. 17) has made a movement toward the third article (C), the third determination unit determines that the first person (X) has acquired the third article (C).

[4]

An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
in the second situation (refer to row Rw2 in FIG. 17), where a first article (B) is placed in a first area, a second article (A) is placed in a second area, and a third article (C) is placed in a third area, the first area being substantially in the center of the shelf in one direction of the shelf, a second and third areas sandwiching the first area on both sides in the one direction, and where the weight of the second article (A) and the weight of the third article (C) are approximately equal and the weight of the first article (B) is approximately twice the weight of the second article (A),
as shown in row Rw2, when the first determination unit determines that the plurality of candidates for the article are one first article (B), one second article (A), and one third article (C), when the most valid candidate article is the one first article (B) and the next most valid candidate articles are the one second article (A) and the one third article (C) and when the second determination unit determines that the first person (X) has made a movement toward the second article (A) and the second person (Y) made a movement toward the third article (C),
the third determination unit determines that the first person (X) has obtained the second article (A) and the second person (Y) has obtained the third article (C).

Note that abbreviated equal includes identical. Abbreviated double includes double.

[5]

An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
in the second situation (refer to row Rw3 in FIG. 17), where a first article (B) is placed in a first area, a second article (A) is placed in a second area, and a third article (C) is placed in a third area, the first area being substantially in the center of the shelf in one direction of the shelf, a second and third areas sandwiching the first area on both sides in the one direction, and where the weight of the second article (A) and the weight of the third article (C) are approximately equal and the weight of the first article (B) is approximately twice the weight of the second article (A),
as shown in row Rw3, when the first determination unit determines that the plurality of candidates for article are one first article (B), one second article (A), and one third article (C), and the most valid candidate articles are the one second article (A) and the one third article (C), and the next most valid candidate article is the one first article (B) and when the second determination unit determines that the first person (X) made a movement toward the first article (B),
the third determination unit determines that the first person (X) has obtained the first article (B).

[6]

An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
in the second situation (refer to row Rw4 in FIG. 17), where a first article (B) is placed in a first area, a second article (A) is placed in a second area, and a third article (C) is placed in a third area, the first area being substantially in the center of the shelf in one direction of the shelf, a second and third areas sandwiching the first area on both sides in the one direction, and where the weight of the second article (A) and the weight of the third article (C) are approximately equal and the weight of the first article (B) is approximately twice the weight of the second article (A),
as shown in row Rw4, when the first determination unit determines that the plurality of candidates for article is one first article (B), one second article (A) and one third article (C), and the most valid candidate article is one first article (B) and the next most valid candidate article is one second article (A) and one third article (C), and when the second determination unit determines that the first person (X) has made a movement toward the second article (A) and the third article (C),
the third determination unit determines that the first person (X) has obtained the one second article (A) and the one third article (C).

[7]

An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
when the article determined to have the highest validity by the first determination unit does not match the article determined by the second determination unit, and the article determined to have the second highest validity by the first determination unit matches the article determined by the second determination unit,
the third determination unit determines that the article determined by the second determination unit has been obtained.

In the article acquisition determination system of [3] to [7], the first determination part, the second determination part, and the third determination part may comprise various programs stored in the ROM 2002 and/or storage device 2004 that are executed by the CPU 2001 of the article identification device 400. In the article acquisition determination system of [3] to [7], validity or adequacy may be determined by the certainty described above.

What is claimed is:

1. An article identification system comprising:
a weight sensor that measures a weight of an article, the weight sensor being installed on a shelf on which the article is placed;
a distance sensor that includes the shelf and a predetermined area in front of the shelf in a measurement range and measures a distance to an object to be measured that is present in the measurement range; and
an article identification device including an information processing device that acquires weight measurement data that is the weight measured with the weight sensor, and distance data that are the distance representing a person present within the measurement range measured with the distance sensor,
wherein,
the information processing device is configured to:
estimate, based on the weight measurement data when the article is picked up from the shelf, the article picked up from the shelf;
calculate, for each of a plurality of picked up estimated articles, a first article picked up position that is an estimated picked up position of the picked up estimated article and a degree of accuracy indicating a degree of correctness of estimation of the picked up estimated article;
obtain, based on the distance data of the person, a second article picked up position based on a position of a predetermined part of the person when the person picks up the article from the shelf;
calculate a corrected accuracy by correcting the accuracy for each of the picked up estimated articles based on the first article picked up position and the second article picked up position; and
identify, based on the corrected accuracy, one or more picked up articles that are picked up from the shelf from among the picked up estimated articles.

2. The article identification system according to claim 1,
wherein
the information processing device is configured to:
correct the accuracy by subtracting from the accuracy a value obtained by multiplying an absolute value of a difference between the first article picked up position and the second picked up position by a weighting factor.

3. The article identification system according to claim 1,
wherein
the information processing device is configured to:
when a plurality of simultaneously picked up estimated articles are present among the picked up estimated articles and the obtained second article picked up position is only one,
calculate an average of the correction accuracy of the picked up estimated articles included in the simultaneously picked up estimated articles; and
identify the picked up estimated article that is not the simultaneously picked up estimated article or the simultaneously picked up estimated article with the highest degree of certainty as the picked up article, based on the average of the correction certainty and the correction certainty of the estimated picked up articles that are not the simultaneously picked up estimated articles.

4. The article identification system according to claim 1,
wherein
the information processing device is configured to:
when a plurality of simultaneously picked up estimated articles are present among the picked up estimated articles and two second article picked up positions are obtained,
calculate an average of the correction accuracy of the picked up estimated articles included in the simultaneously picked up estimated articles;
calculate a sum of the correction accuracy of the picked up estimated articles included in the simultaneously picked up estimated articles;
identify the picked up article based on the correction certainty of the estimated picked up articles that are not the simultaneously picked up estimated articles, the average of the correction certainty, and the sum of the correction accuracy,
identify, when the correction certainty is the highest, the picked up estimated article with the highest certainty that is not the simultaneously picked up estimated article as the picked up article; and
identify, when the average of the correction accuracy is the highest, or when the sum of the correction accuracy is the highest, the simultaneously picked up estimated article as the picked up article.

5. The article identification system according to claim 1,
wherein
the information processing device is configured to:
when a plurality of simultaneously picked up estimated articles are present among the picked up estimated articles and two second article picked up positions based on predetermined parts of two different persons are obtained,
calculate an average of the correction accuracy of the picked up estimated articles included in the simultaneously picked up estimated articles;
calculate a sum of the correction accuracy of the picked up estimated articles included in the simultaneously picked up estimated articles;
identify the picked up article based on the correction certainty of the estimated picked up articles that are not the simultaneously picked up estimated articles, the average of the correction certainty, and the sum of the correction accuracy,
identify, when the correction certainty is the highest, the picked up estimated article with the highest certainty that is not the simultaneously picked up estimated article as the picked up article and the person who picked up the identified picked up article; and
identify, when the average of the correction accuracy is the highest, or when the sum of the correction accuracy is the highest, the simultaneously picked up estimated article as the picked up article and the person who picked up the identified picked up article.

6. The article identification system according to claim 1,
wherein
the information processing device is configured to weight the accuracy before calculating the corrected accuracy.

7. The article identification system according to claim 1,
wherein
the information processing device is configured to identify, when the certainty is greater than or equal to a predetermined threshold certainty, the picked up estimated article having a certainty greater than or equal to the threshold certainty as the picked up article without calculating the corrected certainty.

8. The article identification system according to claim 1,
wherein
the information processing device is configured to obtain the position of the person's hand when the person picks up the article from the shelf as the position of the predetermined part of the person.

9. The article identification system according to claim 8,
wherein
the information processing device is configured to obtain, when the position of the person's hand cannot be obtained and when a predetermined position other than the position of the person's hand can be obtained as the position of the predetermined part of the person, the predetermined position at which the person picks up the article from the shelf as the second article picked up position.

10. The article identification system according to claim 1,
wherein
the information processing device is configured to identify, when the first article picked up position can be obtained, and when the second article picked up position cannot be obtained, the picked up article based on the first article picked up position.

11. The article identification system according to claim 1,
wherein
the information processing device is configured to:
set a predetermined article picked up possibility range based on the second article picked up position; and
exclude the estimated picked up articles that are outside the predetermined article picked up possibility range from the identification target of the picked up article.

12. The article identification system according to claim 1,
wherein
the information processing device is configured to:
set a predetermined first article picked up possibility candidate range based on the first article picked up position;
set a predetermined second article picked up possibility candidate range based on the second article picked up position;
set a range based the predetermined first article picked up possibility candidate range and the predetermined second article picked up possibility candidate range as a range of possibility of picking up the article; and
exclude the picked up estimated articles that are outside the range of the possibility of picking up the article from the identification target of the picked up article.

13. An article identification method to be performed using
a weight sensor that measures a weight of an article, the weight sensor being installed on a shelf on which the article is placed;
a distance sensor that includes the shelf and a predetermined area in front of the shelf in a measurement range and measures a distance to an object to be measured that is present in the measurement range; and
an article identification device including an information processing device that acquires weight measurement data that is the weight measured with the weight sensor, and distance data that are the distance representing a person present within the measurement range measured with the distance sensor,
the article identification method comprising:
estimating, based on the weight measurement data when the article is picked up from the shelf, the article picked up from the shelf;
calculating, for each of a plurality of picked up estimated articles, a first article picked up position that is an estimated picked up position of the picked up estimated article and a degree of accuracy indicating a degree of correctness of estimation of the picked up estimated article;
obtaining, based on the distance data of the person, a second article picked up position based on a position of a predetermined part of the person when the person picks up the article from the shelf;
calculating a corrected accuracy by correcting the accuracy for each of the picked up estimated articles based on the first article picked up position and the second article picked up position; and
identifying, based on the corrected accuracy, one or more picked up articles that are picked up from the shelf from among the picked up estimated articles.

14. A non-transitory computer-readable storage medium that storing a computer-executable program for execution by a computer using:
weight measurement data obtained by a weight sensor that measures a weight of an article, the weight sensor being installed on a shelf on which the article is placed; and
distance data obtained by distance sensor that includes the shelf and a predetermined area in front of the shelf in a measurement range and measures a distance to an object to be measured that is present in the measurement range, the distance data being a distance representing a person present within the measurement range measured with the distance sensor,
the program comprising instructions for:
estimating, based on the weight measurement data when the article is picked up from the shelf, the article picked up from the shelf;
calculating, for each of a plurality of picked up estimated articles, a first article picked up position that is an estimated picked up position of the picked up estimated article and a degree of accuracy indicating a degree of correctness of estimation of the picked up estimated article;
obtaining, based on the distance data of the person, a second article picked up position based on a position of a predetermined part of the person when the person picks up the article from the shelf;
calculating a corrected accuracy by correcting the accuracy for each of the picked up estimated articles based on the first article picked up position and the second article picked up position; and
identifying, based on the corrected accuracy, one or more picked up articles that are picked up from the shelf from among the picked up estimated articles.

15. An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
in a first situation, where a first article is placed in a first region of the shelf in the center of the shelf in one direction, a second region and a third region flanking the first region on both sides in the one direction, a second article is placed in the second region, and a third article is placed in the third region,
the first determination unit determines that the plurality of candidate articles includes one second article and one third article, and that the most valid candidate article is the one second article and the next most valid candidate article is the one third article, and
when the second determination unit determines that the first person has made a movement toward the third article, the third determination unit determines that the first person has acquired the third article.

16. An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
in the second situation, where a first article is placed in a first area, a second article is placed in a second area, and a third article is placed in a third area, the first area being substantially in the center of the shelf in one direction of the shelf, a second and third areas sandwiching the first area on both sides in the one direction, and where the weight of the second article and the weight of the third article are approximately equal and the weight of the first article is approximately twice the weight of the second article,
when the first determination unit determines that the plurality of candidates for the article are one first article, one second article, and one third article, when the most valid candidate article is the one first article and the next most valid candidate articles are the one second article and the one third article and when the second determination unit determines that the first person has made a movement toward the second article and the second person made a movement toward the third article,
the third determination unit determines that the first person has obtained the second article and the second person has obtained the third article.

17. An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
in the second situation, where a first article is placed in a first area, a second article is placed in a second area, and a third article is placed in a third area, the first area being substantially in the center of the shelf in one direction of the shelf, a second and third areas sandwiching the first area on both sides in the one direction, and where the weight of the second article and the weight of the third article are approximately equal and the weight of the first article is approximately twice the weight of the second article,
when the first determination unit determines that the plurality of candidates for article are one first article, one second article, and one third article, and the most valid candidate articles are the one second article and the one third article, and the next most valid candidate article is the one first article and when the second determination unit determines that the first person made a movement toward the first article,
the third determination unit determines that the first person has obtained the first article.

18. An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
in the second situation, where a first article is placed in a first area, a second article is placed in a second area, and a third article is placed in a third area, the first area being substantially in the center of the shelf in one direction of the shelf, a second and third areas sandwiching the first area on both sides in the one direction, and where the weight of the second article and the weight of the third article are approximately equal and the weight of the first article is approximately twice the weight of the second article,
when the first determination unit determines that the plurality of candidates for article is one first article, one second article and one third article, and the most valid candidate article is one first article and the next most valid candidate article is one second article and one third article, and when the second determination unit determines that the first person has made a movement toward the second article and the third article,
the third determination unit determines that the first person has obtained the one second article and the one third article.

19. An article acquisition determination system comprising:
a plurality of weight sensors for detecting a weight of articles, the articles being installed at a distance from each other on a shelf on which a plurality of articles can be placed;
a first detection unit that uses detection results of the weight sensors to detect information including weight distribution on the shelf on which the article is placed;
a first determination unit that determines, using the information detected by the first detection unit, a plurality of candidates for an article obtained from the shelf and validity of the candidates for the article;
a distance sensor that detects a distance to the articles and persons in a vicinity of the shelf;
a second detection unit that uses the detection results in the distance sensor to detect the articles, the persons, and movements of the persons in the vicinity of the shelf;
a second determination unit that uses the detection results of the second detection unit to determine which person made the movement toward which article;
a third determination unit that uses the results of the first determination unit and the results of the second determination unit to determine which person obtained which article,
characterized in that,
when the article determined to have the highest validity by the first determination unit does not match the article determined by the second determination unit, and the article determined to have the second highest validity by the first determination unit matches the article determined by the second determination unit,
the third determination unit determines that the article determined by the second determination unit has been obtained.
